(19) United States
(12) Patent Application Publication
(10) Pub. No.: US 2013/0143555 A1
(43) Pub. Date: Jun. 6, 2013

(54) MANAGING ACCESS TERMINAL HANDOVER IN VIEW OF ACCESS POINT PHYSICAL LAYER IDENTIFIER CONFUSION

(71) Applicant: QUALCOMM Incorporated, San Diego, CA (US)

(72) Inventors: Damanjit SINGH, San Diego, CA (US); Peerapol Tinnakornsrisuphap, San Diego, CA (US); Yeliz Tokgoz, San Diego, CA (US); Mehmet Yavuz, San Diego, CA (US)

(73) Assignee: QUALCOMM Incorporated, San Diego, CA (US)

(21) Appl. No.: 13/689,624

(22) Filed: Nov. 29, 2012

Related U.S. Application Data
(60) Provisional application No. 61/566,562, filed on Dec. 2, 2011.

(51) Int. Cl. H04W 36/00

(52) U.S. Cl. CPC H04W 36/0077
USPC 455/434

(57) ABSTRACT

Confusion associated with a physical layer identifier is detected and action taken to address this confusion. In some aspects, confusion detection involves determining whether signals such as beacons or pilots that are associated with the same physical layer identifier are also associated with different timing (e.g., different observed time difference (OTD) values). In some aspects, confusion detection involves determining whether an inordinate number of handover failures is associated with a particular physical layer identifier. In some aspects, the action taken upon detecting physical layer identifier confusion involves ensuring that an access terminal is not handed over to an access point that uses that physical layer identifier. In some aspects, the action taken upon detecting physical layer identifier confusion involves resolving the confusion.

### CLAIM OF PRIORITY

This application claims the benefit of and priority to commonly owned U.S. Provisional Patent Application No. 61/566,562, filed Dec. 2, 2012, and assigned Attorney Docket No. 120650P1, the disclosure of which is hereby incorporated by reference herein.

### BACKGROUND

1. Field

This application relates generally to wireless communication and more specifically, but not exclusively, to access terminal handover.

2. Introduction

A wireless communication network may be deployed over a defined geographical area to provide various types of services (e.g., voice, data, multimedia services, etc.) to users within that geographical area. In a typical implementation, access points (e.g., corresponding to different cells) are distributed throughout a network to provide wireless connectivity for access terminals (e.g., cell phones) that are operating within the geographical area served by the network.

As the demand for high-rate and multimedia data services rapidly grows, there lies a challenge to implement efficient and robust communication systems with enhanced performance. To supplement conventional network access points (e.g., macro access points), low-power access points may be deployed (e.g., installed in a user's home) to provide more robust indoor wireless coverage or other coverage to access terminals. Such low-power access points may be referred to as, for example, femtocells, femto access points, femto nodes, home NodeBs (HNBs), home eNodeBs (HeNBs), access point base stations, picocells, or pico nodes. Typically, such low-power access points are connected to the Internet via a broadband connection (e.g., a digital subscriber line (DSL) router, a cable modem, or some other type of modem) that provides a backhaul link to a mobile operator's network. Thus, for example, low-power access points can be deployed in user homes to provide mobile network access to one or more devices via the broadband connection. For convenience, the discussions that follow may refer to deployments that use femtocells or femto access points. It should be appreciated, however, that these discussions may be generally applicable to any type of low-power access point.

In general, at a given point in time, an access terminal will be served by a given one of the access points in a network. As the access terminal roams throughout this geographical area, the access terminal may move away from its serving access point and move closer to another access point. In addition, signal conditions within a given cell may change, whereby an access terminal may be better served by another access point. In these cases, to maintain mobility for the access terminal, the access terminal may be handed-over from its serving access point to the other access point.

In a network including femtocells, a femtocell (referred to as the source femtocell) currently serving an access terminal may initiate handover of the access terminal to another femtocell (referred to as the target femtocell). Handover may be triggered, for example, as a result of measurements made by the access terminal that indicate that the access terminal may obtain better signal quality from another neighboring femtocell. Conventionally, target femtocells are identified based on physical layer identifiers (e.g., primary scrambling codes (PSCs), physical cell identifiers (PCIs), etc.) broadcast by the femtocells.

In a network where a large number of femtocells are deployed but a limited number of physical layer identifiers are available for use, more than one femtocell in the same neighborhood may use a common (i.e., the same) physical layer identifier. In this situation, a source femtocell (or some other entity) that controls handover of an access terminal may not be able to distinguish between neighboring femtocells that use the same physical layer identifier or the femtocell (or network entity) may be unaware that neighboring femtocells use the same physical layer identifier. This condition is referred to as physical layer identifier confusion. If confusion is associated with a physical layer identifier that has been identified as a potential target for handover of an access terminal, the correct target femtocell for the handover may not be identified (e.g., the source femtocell may populate an incorrect target femtocell during handover).

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to detecting confusion associated with a physical layer identifier and taking action to address this confusion. In this way, the likelihood of handover failures due to physical layer identifier confusion may be reduced.

In some aspects, confusion detection involves determining whether signals (e.g., beacons or pilots) associated with the same physical layer identifier are also associated with different timing. For example, an access terminal's measurement reports (reporting neighboring access points (e.g., femtocells) detected by the access terminal) may include cell synchronization information. In some aspects, this cell synchronization information may indicate the difference between the timing used by the access terminal and the timing used by a detected access point. From cell synchronization information of different access points, the timing of access points with respect to each other can be obtained. Similar timing information may be detected by a source access point as well in some cases. In general, it is unlikely that two neighboring access points that use the same physical layer identifier will also have the same timing. Hence, a confusion condition may be indicated upon identification of signals that use the same physical layer identifier, but have different timing.

In some aspects, confusion detection involves determining whether an inordinate number of handover failures are associated with a particular physical layer identifier. For example, an access point (e.g., a femtocell) or other entity may keep track of the number of failed handovers and the total number of handovers for a physical layer identifier. The femtocell or entity may then compare the ratio of these two numbers with a threshold to determine whether it is likely that there is confusion associated with that physical layer identifier.

In some aspects, the action taken upon detecting physical layer identifier confusion involves ensuring that an access terminal is not handed over to an access point that uses that physical layer identifier. This action may involve, for example, not handing-over to an access point that uses a physical layer identifier that is subject to confusion. As another example, this action may involve handing-over to an access point that uses a different physical layer identifier than the physical layer identifier that is subject to confusion. As yet another example, this action may involve requesting an access point to change its physical layer identifier to one that is not subject to confusion.

In view of the above, in some aspects, wireless communication in accordance with the teachings herein involves: determining that a plurality of access points use the same physical layer identifier value; and, as a result of the determination, preventing access terminal handover to any access point that uses the physical layer identifier value. In some aspects, wireless communication in accordance with the teachings herein involves: determining that an access terminal is a candidate for handover to an access point that uses a first physical layer identifier value; determining that a plurality of access points use the first physical layer identifier value; and, as a result of the determination that the plurality of access points use the first physical layer identifier value, handing-over the access terminal to another access point that uses a second physical layer identifier value that is different from the first physical layer identifier value. In some aspects, wireless communication in accordance with the teachings herein involves: determining that a plurality of access points use the same physical layer identifier value; and, as a result of the determination, sending a request to at least one of the access points requesting use of a different physical layer identifier value.

In some aspects, the action taken upon detecting physical layer identifier confusion involves resolving the confusion (e.g., uniquely identifying the access points subject to physical layer identifier confusion). A network entity (e.g., a femtocell gateway or HNB gateway) may maintain timing information associated with all of the femtocells associated with that network entity. For example, for each femtocell, this timing may correspond to the timing difference between the femtocell and a local macrocell. Accordingly, whenever a source femtocell detects confusion during a handover operation, the handover message from the source femtocell is modified (i.e., the source femtocell uses a different handover protocol) to send timing information (e.g., cell synchronization information) indicative of the timing of the potential target femtocell (e.g., indicative of the timing difference between the source femtocell and the potential target femtocell) to the network entity. The network entity may then compare a timing difference associated with the target femtocell (e.g., after correlating the timing difference with timing of the local macrocell) with the maintained set of timing differences (i.e., one timing difference for each femtocell). In this way, the network entity may uniquely identify the target femtocell by finding the femtocell from the maintained list that uses the physical layer identifier and that is associated with the timing difference specified by the received timing information.

In view of the above, in some aspects, wireless communication in accordance with the teachings herein involves: receiving information indicative of a timing difference between a first access point (e.g., femtocell) and a second access point (e.g., femtocell); and determining an identity of the first access point based on the received timing information.

In some implementations, the handover message from the source also includes an identifier of a cell (e.g., a local macrocell or the source femtocell). The network entity may then use this identifier to narrow the set of potential femtocells to those femtocells that are near a particular macrocell (i.e., the identified macrocell or the macrocell of the identified source femtocell).

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system;

FIG. 2 is a flowchart of several sample aspects of operations that may be performed in conjunction with potential handover of an access terminal;

FIG. 3 is a simplified block diagram of several sample aspects of a communication system including femtocells deployed with a femtocell gateway;

FIG. 4 is a simplified diagram of illustrating sample aspects of signaling for disambiguation operations;

FIG. 5 is a flowchart of several sample aspects of operations that may be performed in conjunction detecting physical layer identifier confusion;

FIG. 6 is a flowchart of several sample aspects of operations that may be performed in conjunction with detecting physical layer identifier confusion;

FIG. 7 is a flowchart of several sample aspects of operations that may be performed in conjunction with detecting physical layer identifier confusion;

FIG. 8 is a flowchart of several sample aspects of operations that may be performed to resolve physical layer identifier confusion;

FIG. 9 is a flowchart of several sample aspects of operations that may be performed to recognize PSC confusion;

FIG. 10 is a flowchart of several sample aspects of operations that may be performed to recognize PSC confusion;

FIG. 11 is a flowchart of several sample aspects of operations that may be performed to recognize PSC confusion;

FIG. 12 is a flowchart of several sample aspects of operations that may be performed to recognize PSC confusion;

FIG. 13 is a flowchart of several sample aspects of operations that may be performed for PSC confusion disambiguation;

FIG. 14 is a simplified block diagram of several sample aspects of components that may be employed in communication apparatuses;

FIG. 15 is a block diagram of several sample components of an example femtocell;

FIG. 16 is a block diagram of several sample components of an example gateway;

FIG. 17 is a block diagram of several sample components of an example user equipment;

FIG. 18 is a simplified diagram of a wireless communication system;

FIG. 19 is a simplified diagram of a wireless communication system including femto nodes;

FIG. 20 is a simplified diagram illustrating coverage areas for wireless communication;

FIG. 21 is a simplified block diagram of several sample aspects of communication components; and

FIGS. 22-25 are simplified block diagrams of several sample aspects of apparatuses configured to provide handover-related functionality as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

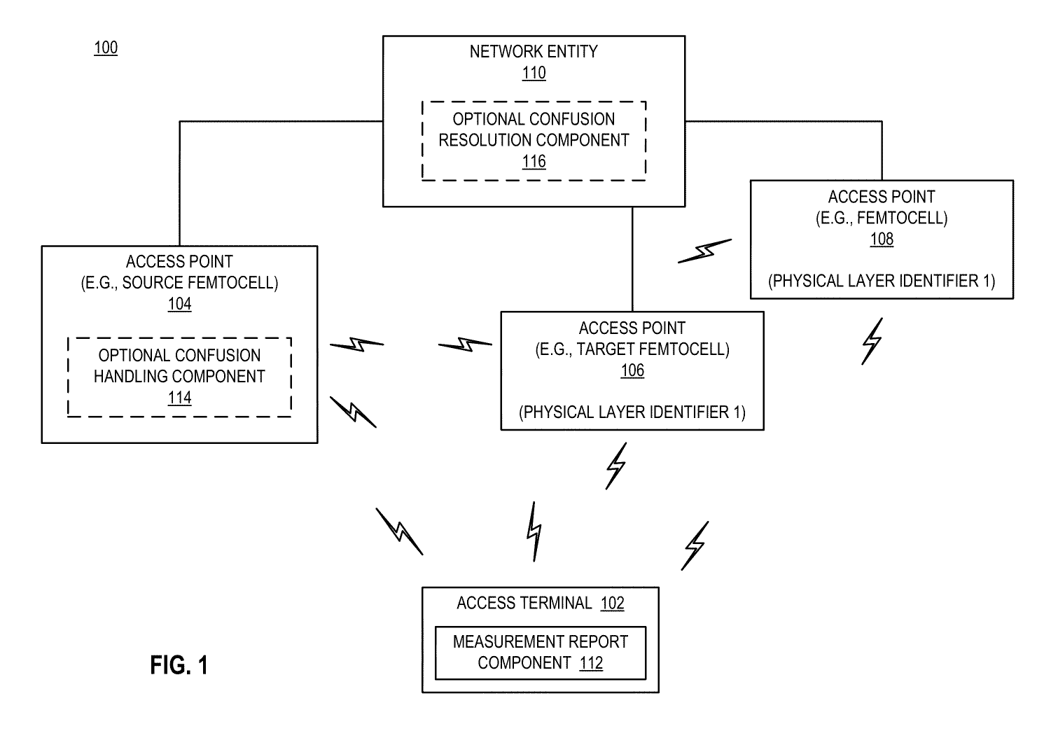

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, femtocells, and so on, while access terminals may be referred to or implemented as user equipment (UEs), mobile stations, and so on.

Access points in the system 100 provide access to one or more services (e.g., network connectivity) for one or more wireless terminals (e.g., an access terminal 102) that may be installed within or that may roam throughout a coverage area of the system 100. For example, at various points in time the access terminal 102 may connect to an access point 104, an access point 106, an access point 108, or some access point in the system 100 (not shown). Each of these access points may communicate with one or more network entities (represented, for convenience, by a network entity 110) to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. In some implementations the network entities represent femtocell gateway functionality. Two or more of these network entities may be co-located and/or two or more of these network entities may be distributed throughout a network.

Each access point in the system 100 may be assigned a first type of identifier that may be used to readily identify the access point. In various implementations such an identifier may comprise, for example, a physical layer identifier or some other suitable identifier. Typically, a fixed quantity of identifiers (e.g., 512 or less) is defined for a given system.

As the access terminal 102 roams through the system 100, it may be desirable to hand-over the access terminal 102 from a source access point (i.e., the serving access point to which the access terminal is currently connected, e.g., the access point 104) to a target access point (e.g., the access point 106). This decision may be based, for example, on whether the access terminal 102 is receiving particularly strong pilot signals (e.g., exceeding a threshold) from that target access point.

To enable handover of the access terminal 102, the access terminal 102 monitors for signals (e.g., a pilot signal, a beacon, etc.) from potential target access points. This signal may comprise (e.g., include or be encoded or scrambled with) a physical layer identifier of the potential target access point. To this end, the access terminal 102 includes a measurement report component 112 that acquires the signals broadcast by nearby access points, and sends a message (e.g., a measurement report) including the identifier, an indication of the associated received signal strength (e.g., RSSI), and timing information to the current serving access point (e.g., the access point 104) of the access terminal 102. The serving access point (or a network entity) may then decide based on the measurement report whether to hand-over the access terminal 102 to the target access point.

In the absence of identifier confusion, the physical layer identifier acquired by the access terminal 102 may be unambiguously mapped to a more unique identifier assigned to the target access point, whereby the more unique identifier is used to set up the target access point for handover of the access terminal 102. This second identifier is more unique than the first identifier in the sense that it enables unambiguous identification of the target access point within an area of interest. For example, the more unique identifier may be unique within a larger geographic area, may be unique within an entire network (e.g., a public land mobile network (PLMN)), may be globally unique, or may be more unique in some other manner. In various implementations such an identifier may comprise, for example, a cell identifier (e.g., a CGI) or some other suitable identifier.

In some systems, the more unique identifier is not included in measurement report messages (e.g., due to the identifier not being broadcast by access points or due to high overhead that would be associated with including this identifier in the measurement report messages). Consequently, due to the limited number of physical layer identifiers available for use, if a large number of access points (e.g., femtocells) are deployed in the same neighborhood, several of these access points may be assigned the same physical layer identifier (e.g., PSC). In this case, physical layer identifier confusion may arise during handover operations if the measurement report messages only include the physical layer identifier. FIG. 1 illustrates a simple example where the access point 106 and the access point 108 are both assigned a physical layer identifier value of “1.” When such confusion does exist, upon receiving a measurement report message, the source access point may not be able to uniquely identify the access point that is the desired target access point for handover of the access terminal 102. For example, the access point 104 and/or the network entity 110 may not be able to determine whether to communicate with the access point 106 or the access point 108 to reserve resources for handover of the access terminal 102.

Physical layer identifier confusion such as this may be identified and/or handled (e.g., resolved) through the use of one or more of the techniques described herein. To this end, access points (e.g., femtocells) in the system 100 may optionally include confusion handling components 114 that are capable of detecting physical layer identifier confusion and taking appropriate action to mitigate undesired consequences that may arise from such confusion. In addition, one or more network entities in the system 100 may optionally include confusion resolution components 116 that are capable of resolving physical layer identifier confusion.

In cases where the confusion is resolved, the target access point is prepared for handover of the access terminal 102. For example, the serving access point (i.e., the source access point for the handover) may communicate with the target access point to reserve resources for the access terminal. In a typical scenario, context information maintained by the serving access point may be transferred to the target access point and/or context information maintained by the target access point may be sent to the access terminal 102.

The handover may then be completed assuming the correct target access point was prepared for the handover. Here, the access terminal and the target access point may communicate with one another in accordance with conventional handover procedures.

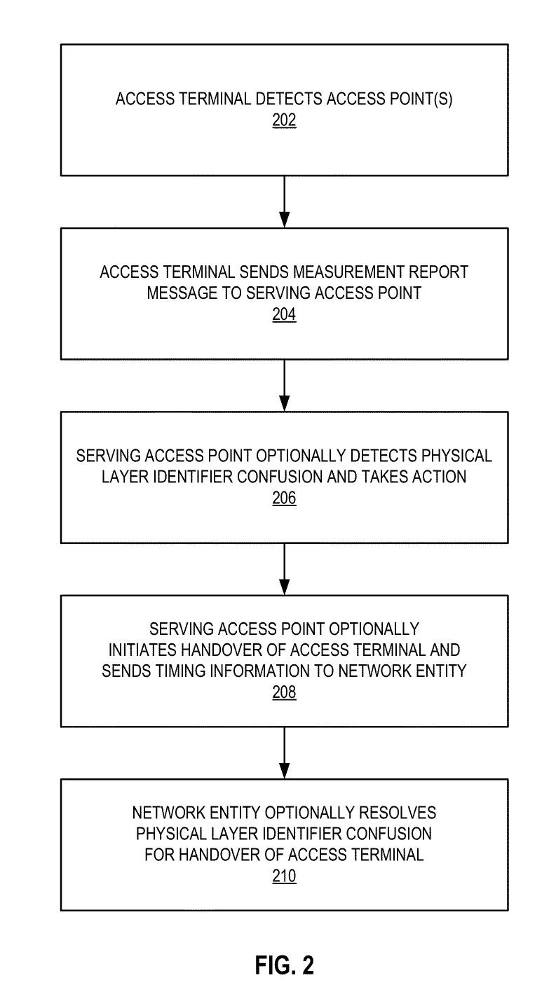

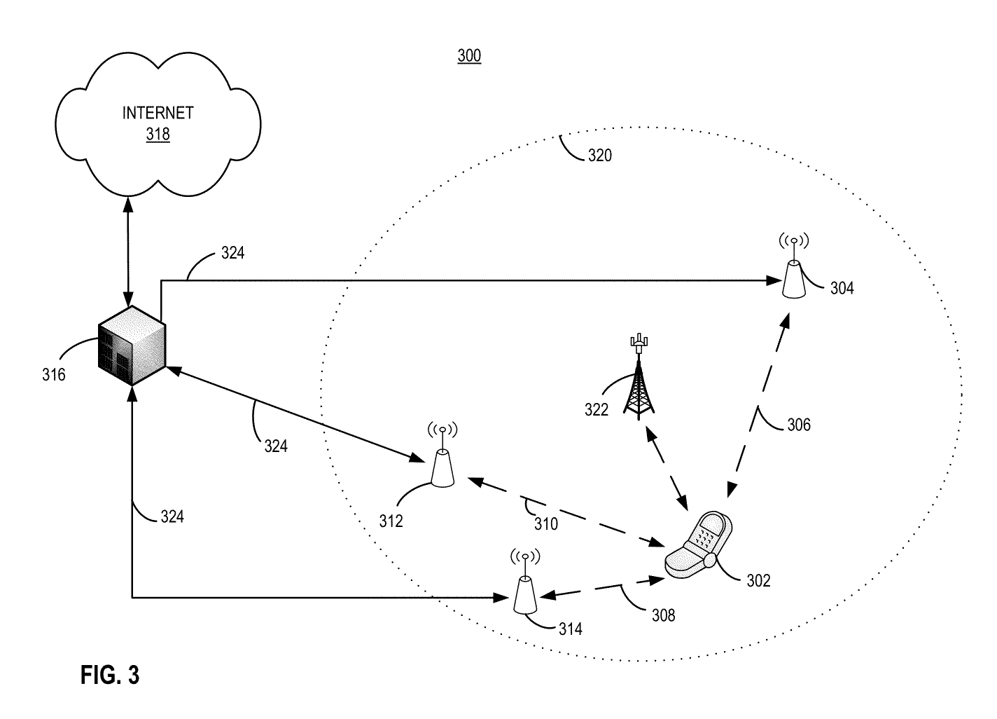

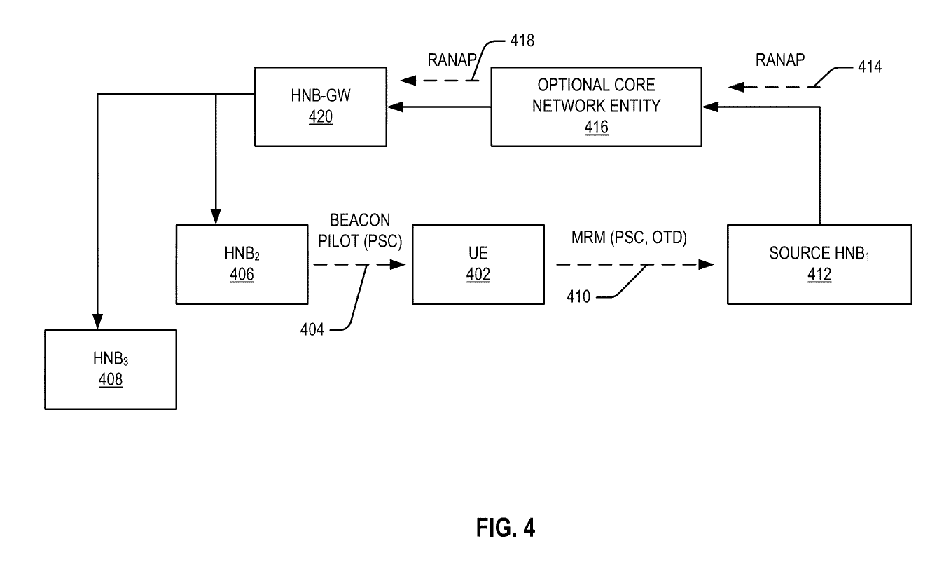

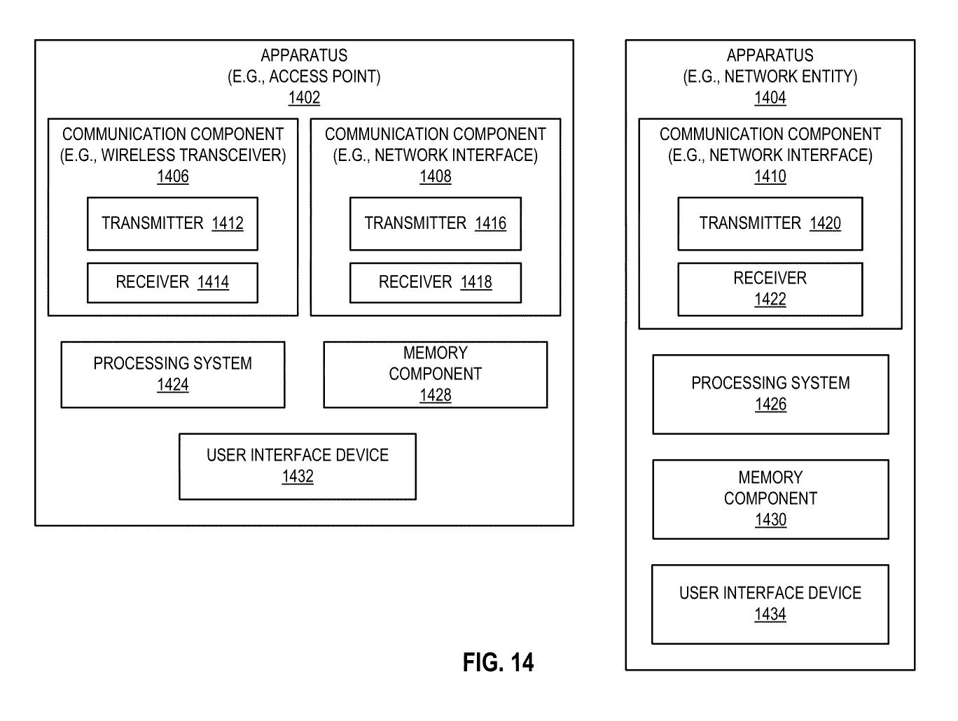

With the above in mind, sample physical layer identifier confusion-related operations will be described in more detail in conjunction with the flowchart of FIG. 2. For convenience, the operations of FIG. 2 (or any other operations discussed or taught herein) may be described as being performed by specific components (e.g., components of FIG. 1, FIG. 3, FIG. 4, FIG. 14, etc.). It should be appreciated, however, that these operations may be performed by other types of components and may be performed using a different number of components. It also should be appreciated that one or more of the operations described herein may not be employed in a given implementation.

As represented by block 202 of FIG. 2, at some point in time an access terminal detects one or more nearby access points. For example, the access terminal may acquire pilot signals or some other suitable signal broadcast by the access point(s). In some aspects, the acquisition of a given signal may involve determining the physical layer identifier associated with a received signal (e.g., an identifier included within the signal, an identifier that was used to encode the signal, etc.). In addition, in some aspects, the acquisition of a given signal may involve determining timing of the received signal. For example, an access terminal may monitor one or more of a synchronization channel, a pilot channel, or a broadcast channel to determine the timing of the access point that transmitted these channels. In some implementations, this timing information (e.g., cell synchronization information) represents, in terms of a number of radio frames (e.g., 10 millisecond frames) and a number of chips, the difference between the internal clock timings used by the access terminal and the received signal of access points.

As represented by block 204, the access terminal sends a measurement report message to its source access point. For each reported signal, the measurement report message may indicate, for example, the physical layer identifier, the timing information, and the RSSI associated with the signal. Also, in some scenarios, the measurement report message may include a unique identifier (e.g., a global cell identifier) associated with a reported signal.

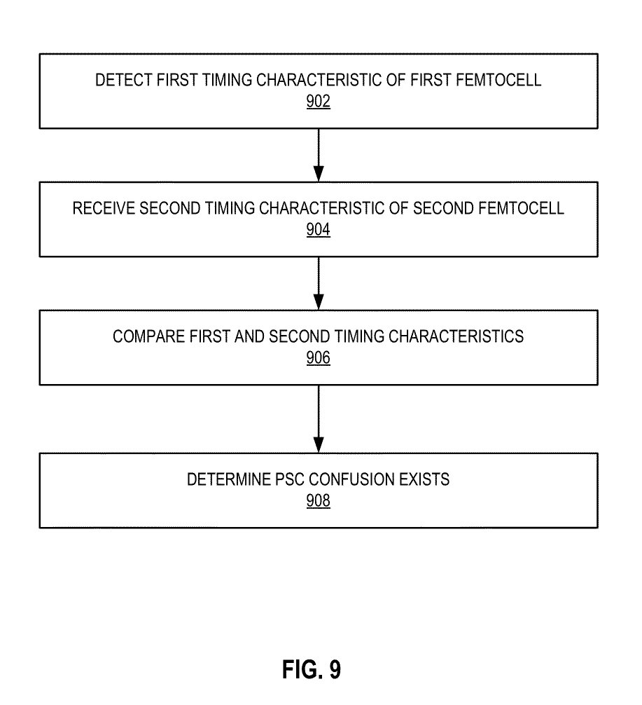

As represented by block 206, in some implementations, the source access point detects physical layer identifier confusion based on received measurement report messages and/or other received information (e.g., broadcast signals received via a network listen module of the access point). For example, confusion is indicated if the same physical layer identifier is associated with two signals that are associated with different timings. As another example, confusion is indicated if the same physical layer identifier is associated with two signals that are associated with different global cell identifiers. Several examples of confusion detection operations are described in more detail below in conjunction with FIGS. 9-12.

Upon detecting physical layer identifier confusion, the source access point may take appropriate action in an attempt to ensure that any physical layer identifier confusion does not adversely affect handover operations or other operations. For example, the source access point may take action to prevent handover failures that could otherwise result from the use of the physical layer identifier that is in confusion.

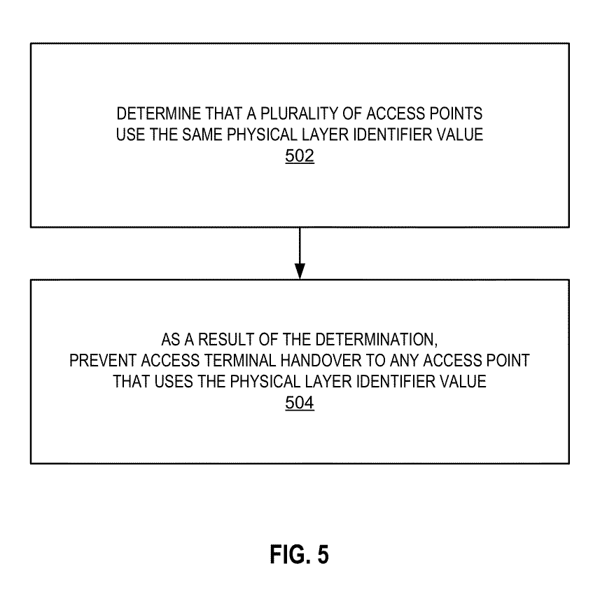

In some implementations, the source access point takes action to ensure that an access terminal will not be handed-over to an access point that is using a physical layer identifier that is subject to confusion. For example, the source access point may disable all handovers to any access point that uses a physical layer identifier that has been identified as being subject to confusion. As another example, the source access point may hand-over the access terminal to an access point (e.g., another potential target that was seen by the access terminal) that uses a physical layer identifier that is different from the physical layer identifier subject to confusion. As yet another example, the source access point may send a request that requests an access point to change its physical layer identifier to one that is not subject to confusion. These operations are described in more detail below in conjunction with FIGS. 5-7.

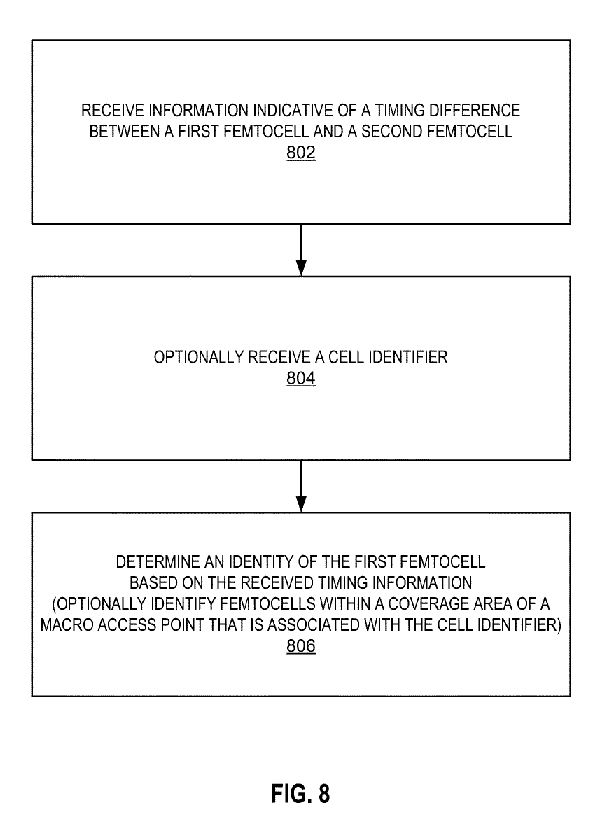

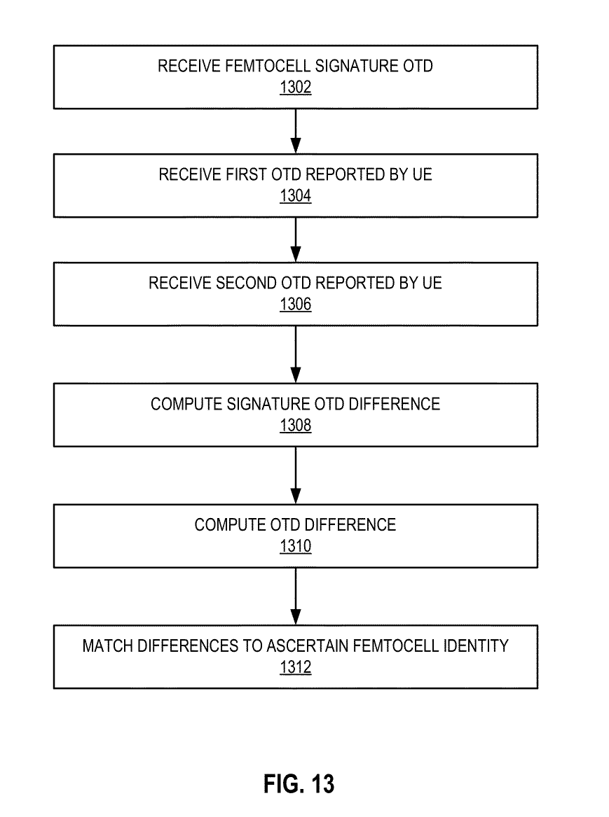

As represented by blocks 208 and 210, in some implementations, steps are taken to resolve physical layer identifier confusion. At block 208, the serving access point initiates handover of the access terminal by sending a handover message to a network entity. This handover message includes conventional handover information (e.g., target physical layer identifier, etc.) along with timing information (e.g., the cell synchronization information) from the measurement report message. At block 210, the network entity uses the physical layer identifier and timing information to resolve the confusion. For example, the network entity may maintain a database that indicates, for each access point (e.g., femtocell) in a network, the physical layer identifier used by that access point and the timing difference between that access point and the other access points in the network. Consequently, the network entity may uniquely identify the target access point for the handover operation by identifying the access point entry from the database that includes the physical layer identifier and timing information (relative to the source access point) that matches the physical layer identifier and timing information included in the handover message. Several examples of confusion detection operations are described in more detail below in conjunction with FIGS. 8 and 13.

Referring now to FIGS. 3 and 4, for purposes of illustration, additional aspects of the disclosure will be described in the context of a wireless communication environment that includes femtocells (e.g., HNBs). In these examples, the femtocells are controlled by a gateway (e.g., a HNB gateway (HNB-GW)).

The environment 300 of FIG. 3 includes a user equipment (UE) 302, a source femtocell 304, one or more target femtocells (e.g., 314, 312), a gateway 316 (e.g., HNB-GW) which is connected to a core network via the Internet 318. Furthermore, the gateway 316 may be connected to one or more femtocells through communicative connections 324. Additionally, the wireless network may contain a neighboring macrocell, which may be controlled by a macro access point 322. In some aspects, the UE 302 may communicate with the source femtocell 304 via a communication link 306 and with target femtocells 312 and 314 via communication links 308 and 310, respectively. Communication links 306, 308, 310, or any other over the air (OTA) communication link may utilize one or more of a variety of technologies, for example, UMTS, GSM, TD-SCDMA, WiMAX, and LTE.

In some aspects, the UE 302 may detect the presence of a wireless network node, such as a femtocell, that may exhibit better qualities than a femtocell currently serving the UE 302. For example, the UE 302 may continuously monitor the frequency spectrum for beacon signals from new femtocells to add to an active set associated with the UE 302. In the event that the UE 302 detects a beacon signal that indicates a stronger wireless signal exists, the UE 302 or the network may initiate a handover operation, whereby the UE 302 is handed-over to the femtocell with the stronger signal.

For example, in FIG. 3, the UE 302 may be served by a first femtocell, which may be referred to as a source femtocell 304. As the UE 302 travels in space, it may detect a beacon signal 320 transmitted by, for example, by a second femtocell, which may be referred to as a first target femtocell 312 and may have an associated PSC. Because femtocells may be deployed with minimal or no planning, it is possible that a third femtocell, which may be referred to as a second target femtocell 314 may share the same PSC as the first target femtocell 312 and may also be a neighbor of, i.e., have an overlapping coverage with, the serving femtocell 304.

In handover, the source femtocell may attempt to prepare a target femtocell for the handover of the UE 302 based on a PSC associated with the target femtocell. Because in the above scenario more than one neighboring femtocell of a source femtocell 304 may possess the same PSC, the source femtocell 304 is unable to differentiate from the first target femtocell 312 and the second target femtocell 314. Therefore, the first and second target femtocells are in PSC confusion. During PSC confusion, the source femtocell may be unable to differentiate between the first target femtocell and the second target femtocell. As a result, the source femtocell may choose the incorrect target femtocell and inadvertently prepare the wrong femtocell for the handover.

FIG. 4 illustrates an example of signaling and operations that may be employed to detect PSC confusion and resolve this confusion. Once a network device, for example a source femtocell (HNB₁) 412 or a gateway (HNB-GW) 420, is aware that PSC confusion exists between more than one target femtocell on a network during a contemplated handover, the gateway 420 may help in narrowing down to a correct target femtocell to which the UE 402 should be transferred.

To facilitate this functionality, at some point in time (e.g., as each femtocell boots), each femtocell may measure and maintain a timing difference between its native timing and that of a neighboring macrocell located on a macro network. Due to the high resolution and precision of clocks and related frequencies on these devices, it is unlikely that more than one femtocell will measure the same timing difference relative to the timing of the given macrocell. As such, this maintained timing difference, which may be centrally maintained at the gateway 420 (or some other entity), may serve as an identifier, or signature observed time difference, for each femtocell in the wireless communication environment. In an example, this observed time difference or signature may be referred to as relative reference Observed Time Difference (OTD), ΔRefOTD, or a signature OTD. As stated above, each femtocell may communicate its signature OTD to the gateway 420, which may maintain this value in a database. Additionally, the gateway 420 may maintain the identity of one or more neighboring macrocells (e.g., macro access points), which could utilize the same or a different frequency as devices in a femtocell environment. In this way, the gateway 420 may maintain the identity and a reference timing upon which at least one RefOTD, ΔRefOTD, OTD, and/or ΔOTD may be based.

As the UE 402 travels in the environment, it may move within range of two femtocells, which may be target femtocells, for example target femtocell 406 (HNB₂) and target femtocell 408 (HNB₃). The UE 402 may observe the timing characteristic (e.g., the cell synchronization information) of each of femtocell 406 and 408 relative to, for example, UE 402 and/or the source femtocell 412. For example, the UE 402 may receive a beacon pilot 404 from the femtocell 406 and determine the signal timing relative to the timing of the UE 402. As indicated in FIG. 4, the beacon pilot 404 is associated with (e.g., includes or is encoded based on) a specific PSC value.

The UE 402 may then report the timing characteristic (e.g., the cell synchronization) of each of femtocell 406 and 408 to, for example, the source femtocell 412 or the gateway 420. As shown in FIG. 4, the UE 402 sends a measurement report message (MRM) 410 to the source femtocell 412. The MRM 410 includes the PSC and the cell synchronization information associated with each observed femtocell. In some cases, the MRM 410 reports the UE timing relative to each of the femtocells seen by the UE 402. For example, an OTD_{HNB1} may indicate the UE timing relative to the source HNB₁, an OTD_{HNB2} may indicate the UE timing relative to the target HNB₂, and so on. From these reported timing characteristics, a difference in the reported timings (AOTD) may be calculated. Again, for clarity, in an aspect, the UE 402 may report the timing characteristics of one or more target femtocells, the difference in the timing characteristics being defined as an OTD or timing difference (AOTD).

In the example of FIG. 4, the source femtocell 412 sends a radio access network application part (RANAP) message to initiate handover of the UE 402. In different embodiments, this message may be sent either to the core network or directly to the gateway 420.

In implementations where the core network is involved in the handover, the source femtocell 412 sends a Relocation Required message 414 to a core network entity (or entities) 416. The message 414 includes the information from the MRM 410, an identifier of the gateway 420, along with a cell identifier. The cell identifier identifies a neighboring macrocell or the source femtocell 412. As discussed below, the cell identifier is used to directly identify (i.e., for the case of a macrocell identifier) or indirectly identify (i.e., for the case of a source femtocell identifier) a macrocell associated with the UE 402 to facilitate the disambiguation procedure. As indicated in FIG. 4, the core network entity 416 sends a RANAP Relocation Request message 418 to the gateway 420. The message 418 includes the information from the MRM 410, and the cell identifier (e.g., that identifies the neighboring macrocell or the source femtocell 412).

In implementations where the core network is not involved in the handover, the source femtocell 412 sends a message directly to the gateway 420 (e.g., via a lur-h interface). This message includes the information from the MRM 410 and a cell identifier (e.g., that identifies the neighboring macrocell or the source femtocell 412).

Separate from the above handover operations, the gateway 420 maintains ΔRefOTD parameters for each femtocell under its control. The ΔRefOTD parameter is the difference in signature timing characteristics computed at the gateway based on signature timing difference RefOTD values that the femtocells reported to the gateway. Each RefOTD value indicates the timing of a given femtocell relative to a neighboring macrocell. Thus, in some aspects, the RefOTD value may be considered to provide a “signature” of that femtocell within that macrocell.

Accordingly, for each femtocell under its control, the gateway 420 (or some other suitable network entity) maintains information about neighboring macrocells and timing information associated with that femtocell.

One or more macrocells may be associated with a femtocell. A given macrocell may be on the same frequency or a different frequency than the femtocell. A given macrocell may belong to the same operator or a different operator than the femtocell.

The gateway 420 may acquire the macrocell information in various ways. For example, a femtocell may communicate its neighboring macrocell identifier to a HNB-GW via a HNB Register Request message. In cases where only one neighboring macrocell identifier may be communicated by such a message, the femtocell may need to use other messaging mechanisms to supply the identifiers of any other neighboring macrocells associated with the femtocell. In some implementations, a femtocell may communicate its neighboring macrocells via a proprietary message. In some implementations, a HNB management server (HMS) may send neighboring macrocell information for each femtocell to a HNB-GW.

In some aspects, the timing information associated with a given femtocell may indicate the timing (e.g., at a chip level) of the femtocell with respect to each neighboring macrocell. As discussed herein, this timing information may be referred to as ΔRefOTD.

The gateway 420 may acquire the timing information in various ways. For example, a femtocell may send its timing information to the gateway 420 via a proprietary message. As another example, a HNB management server may communicate this information for each femtocell to a HNB-GW.

Referring again the specific case of the handover of the UE 402, by comparing the ΔOTD obtained from the cell synchronization information reports in the MRM with the ΔRefOTD parameters stored in the database (for the corresponding macrocell), the gateway 420 may ascertain with a high likelihood the identities of the target femtocells associated with the reported ΔOTD (assuming a match is found). By this method, any PSC confusion (e.g., between the femtocells 406 and 408) may be resolved such that the correct target femtocell is selected for handover of the UE 402.

Here, it should be appreciated that the cell identifier information provided in the MRM is used to limit the database search to those femtocells that are under the same macrocell as the UE 402. As indicated above, the cell identifier may either comprise the cell ID of the neighboring macrocell or the cell ID of the source femtocell. In the latter case, the gateway 420 may map the source femtocell's cell ID to the corresponding neighboring macrocell cell ID.

In practice, the clocks of the femtocells may drift over time. Consequently, the ΔOTD and/or ΔRefOTD values may need to be updated on occasion. For example, femtocells may periodically synchronize/update their ΔRefOTD values with respect to neighboring macrocells.

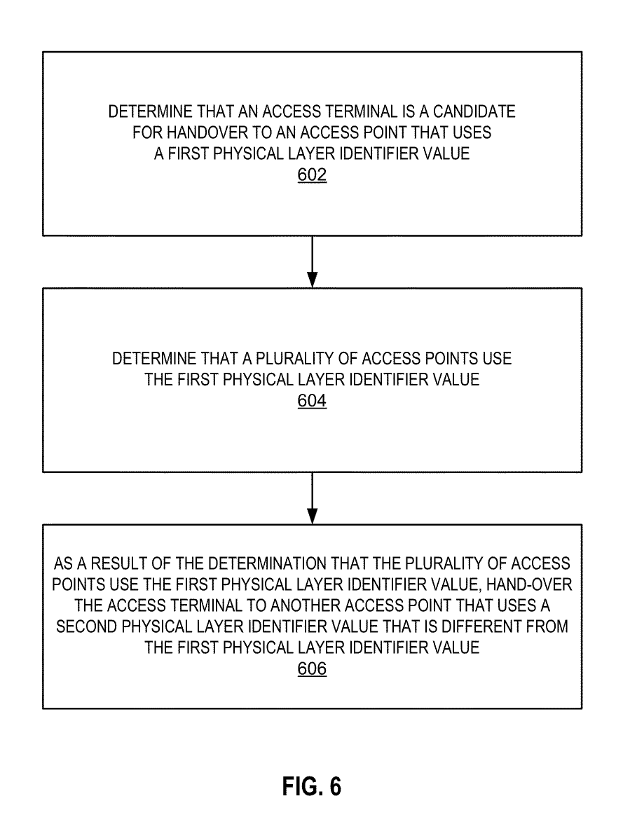

FIGS. 5 and 6 illustrate sample operations that may be performed in accordance with the teachings herein to identify physical layer identifier confusion and take action to mitigate adverse conditions that could otherwise arise from the confusion. These operations may be performed, for example, by a gateway (e.g., a HNB-GW), a femtocell, or some other entity.

FIG. 5 relates to preventing handovers to access points that use a physical layer identifier that is subject to confusion.

As represented by block 502, a determination is made that a plurality of access points use the same physical layer identifier value (e.g., PSC). This determination may be made, for example, through the use of one or more of the techniques described herein. For example, this may involve detecting physical layer identifier confusion based on receipt of signals that are associated with the same physical layer identifier value (e.g., a value of “1,” etc.) but with different timing.

Thus, in some aspects, the determination that the plurality of access points use the same physical layer identifier value may comprise determining whether received signals comprising the physical layer identifier value are associated with different timing. Here, the different timing may comprise: a first timing difference between a first one of the access points and a reference access point; and a second timing difference between a second one of the access points and the reference access point. In some aspects, the reference access point comprises a serving access point (e.g., of an access terminal that received at least some of the signals). In some aspects, at least one of the first timing difference and the second timing difference is obtained using cell synchronization information.

In some aspects, the determination that the plurality of access points use the same physical layer identifier value comprises determining whether received signals comprising the physical layer identifier value are associated with different cell identities. In some aspects, the cell identities are unique within a public land mobile network.

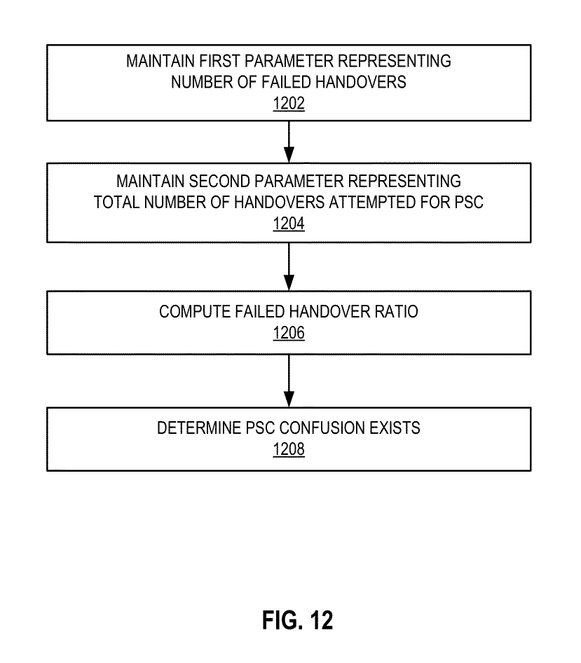

Alternatively or in addition, in some aspects, the determination that the plurality of access points use the same physical layer identifier value comprises determining that a value based on a quantity of handover failures associated with the physical layer identifier meets or exceeds a threshold. An example of this operation is described in more detail below in conjunction with FIG. 12.

As represented by block 504, as a result of the determination of block 502, action is taken to prevent access terminal handover to any access point that uses the physical layer identifier value. For example, a femtocell may maintain a record of this value whereby, in the event the femtocell receives a MRM including this value from an access terminal, the femtocell may abstain from invoking a handover operation based on this value (e.g., even if this value is associated with the highest measured RSCP or Edo value in the MRM).

FIG. 6 relates to handing an access terminal over to another access point that uses a physical layer identifier that is not subject to confusion.

As represented by block 602, a determination is made that an access terminal is a candidate for handover to an access point that uses a first physical layer identifier value (e.g., a PSC value of “1”). For example, this determination may be made based on receipt of an MRM that includes the first physical layer identifier value from the access terminal.

As represented by block 604, a determination is made that a plurality of access points use the first physical layer identifier value. These operations may involve operations similar to those described above for block 502.

As represented by block 606, as a result of the determination of block 604, the access terminal is handed-over to another access point that uses a second physical layer identifier value (e.g., a value of “2) that is different from the first physical layer identifier value.

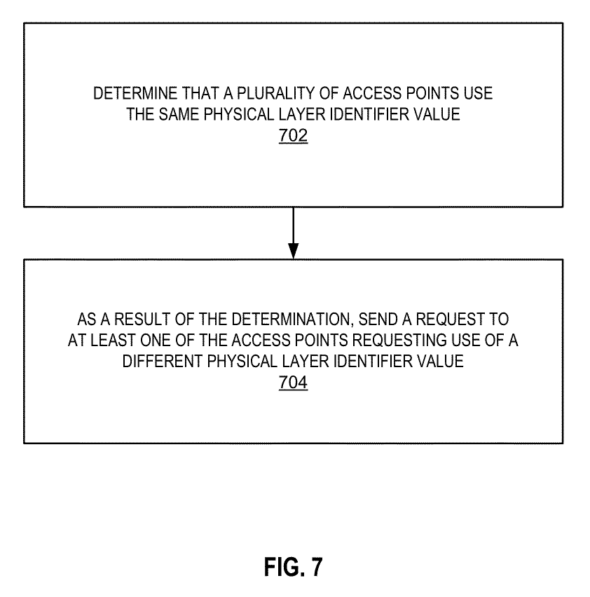

FIGS. 7 and 8 illustrate sample operations that may be performed in accordance with the teachings herein to identify physical layer identifier confusion and take action to correct the confusion. These operations may be performed, for example, by a gateway (e.g., a HNB-GW), a femtocell, or some other entity.

FIG. 7 relates to requesting an access point to change its physical layer identifier.

As represented by block 702, a determination is made that a plurality of access points use the same physical layer identifier value (e.g., PSC). These operations may involve operations similar to those described above for block 502.

As represented by block 704, as a result of the determination of block 702, a request is sent to at least one of the access points requesting use of a different physical layer identifier value. In this way, the access points that were using the same physical layer identifier may be reconfigured to use different physical layer identifiers.

FIG. 8 relates to a sample method for resolving the physical layer identifier confusion.

As represented by block 802, information is received that is indicative of a timing difference between a first femtocell and a second femtocell. For example, a gateway may receive this information via a RANAP message. In some aspects, the timing information comprises: a first cell synchronization information associated with the first femtocell; and a second cell synchronization information associated with the second femtocell. In some aspects, the received timing information comprises: a first timing difference between the first femtocell and a reference access point; and a second timing difference between the second femtocell and the reference access point. In some aspects, the reference access point is a serving access point. In some aspects, at least one of the first timing difference and the second timing difference is obtained using cell synchronization information.

As represented by block 804, a cell identifier is optionally received. For example, the RANAP message of block 802 also may include a cell identifier as discussed herein. Thus, in some aspects, the cell identifier identifies a cell of a macrocell associated with the access terminal that reported the timing of the first and second femtocells. Alternatively, in some aspects, the cell identifier identifies a cell of the second femtocell (e.g. the source femtocell for handover of the access terminal to the first femtocell).

As represented by block 806, an identity of the first femtocell is determined based on the received timing information. In this way, confusion associated with a physical layer identifier used by both the first and second femtocells may be resolved. In some cases, the determination of the identity comprises identifying femtocells within a coverage area of a macro access point that is associated with the cell identifier received at block 804. In some aspects, the determination of the identity comprises: comparing a first time difference based on the received information with a plurality of time differences associated with a set of femtocells; identifying one of the plurality of time differences that best matches the first time difference; and determining an identity of each femtocell associated with the identified time difference.

FIGS. 9-12 illustrate sample operations that may be performed in accordance with the teachings herein to identify physical layer identifier confusion. These operations may be performed, for example, by a gateway (e.g., a HNB-GW), a femtocell, or some other entity.

Referring initially to FIG. 9, in some instances, a femtocell, such as a source femtocell, may receive an indication that a UE has discovered a target femtocell with a reported PSC to which the UE should be transferred. The decision to transfer the UE to a new femtocell via handover can be executed by, for example, the source femtocell, a target femtocell, a gateway, or other device in a wireless communication environment. Once the decision to handover the UE from the source femtocell to a target femtocell is executed, the source femtocell may seek to populate the correct target femtocell with the UE for post-handover communication. If more than one femtocell under a gateway shares the same PSC, however, PSC confusion may exist, and the source femtocell may therefore populate an incorrect target femtocell at handover.

FIG. 9 illustrates one method by which the PSC confusion can be detected by a home femtocell. First, a source femtocell may detect a first timing characteristic associated with a first femtocell, which may be a first target femtocell at block 902. Alternatively, the detecting may be accomplished by a UE in an aspect. By detecting this first timing characteristic, the source femtocell may ascertain the target home node timing with respect to its own source femtocell timing. A timing characteristic, or timing, as used in the present disclosure, may be, for example, a chip-level timing associated with a femtocell or macrocell (e.g. a base station). The timing characteristic may be computed relative to some reference timing, which may be associated with the timing of a macrocell device such as a neighboring macrocell access point (e.g., 322 in FIG. 3).

Next, a femtocell may receive a second timing characteristic associated with a second femtocell, which may be a second target femtocell, from a UE at block 904. In an aspect, the second timing characteristic may be reported by a UE as it enters a communicative range associated with the second target femtocell, and may, for example, receive a beacon signal from the second target femtocell. Additionally, this second femtocell may report the same PSC as the first femtocell.

In an aspect, once the source femtocell has detected the first timing characteristic and received the second timing characteristic from the UE, the source femtocell may compare the first timing characteristic and the second timing characteristic at block 906. Where this comparison results in a determination that the first timing characteristic differs from the second timing characteristic, the source femtocell may determine that PSC confusion exists between the first and second target femtocells at block 908. This determination may be made because there is a high probability (due to inherently-high clock resolution) that each observed timing characteristic is associated with a unique femtocell. Thus, if a timing characteristic difference exists while the same PSC is reported by two target femtocells, the target femtocells are likely in PSC confusion.

The method of FIG. 9 and all other methods of the present disclosure may assume ideal clocks associated with all devices involved in the described methods. That is to say, the clock periods or frequencies associated with these devices mat be assumed to be time invariant. However, as many femtocells in practical wireless communication environments do not exhibit perfect frequency retention over time, clock drift may occur in one or more femtocells or other devices in the methods and apparatuses disclosed herein. Therefore, clock drift may be accounted for in the present disclosure. One method of accounting for clock drift may include each femtocell periodically checking its clock timing relative to a neighboring macrocell clock timing and reporting any clock drift or other ambiguity to a gateway device. Thus, by periodically checking its clock and reporting the resulting clock timing to the gateway, other devices may access the true clock timing characteristics of a given femtocell by querying the gateway.

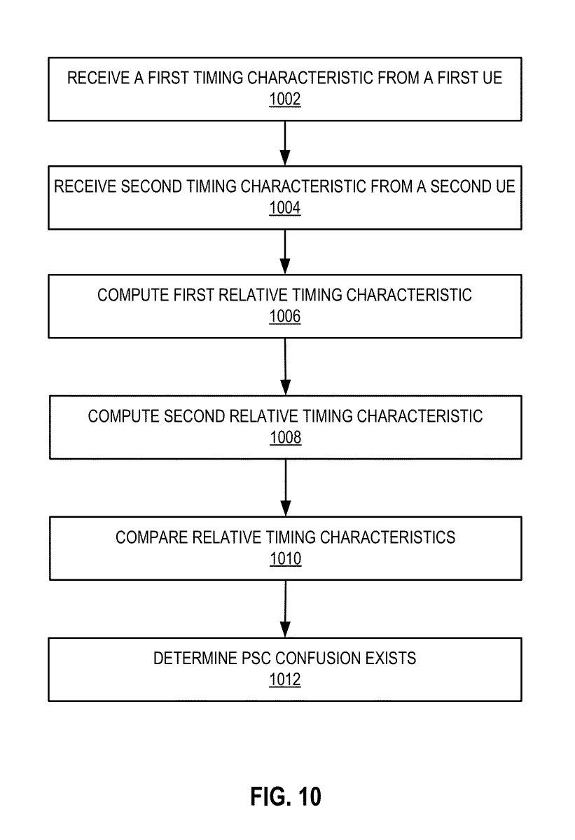

Referring to FIG. 10, as a plurality of UEs travel in a wireless communication environment, timing characteristics of a plurality of target femtocells may be obtained by the plurality of UEs and reported to a source femtocell. For example, one of the UEs may reside relatively close to a first target femtocell while a second UE may reside relatively close to a second target femtocell that reports the same PSC as the first target femtocell. These UEs may report the timing characteristics of the first timing femtocell and the second target femtocell to the source femtocell, which may compare these reported timing characteristics with a native timing characteristic associated with the source femtocell to compute a relative timing characteristic for each of the first and second target femtocells. If these relative timing characteristics differ, the source femtocell may conclude that the first and second target femtocells are in PSC confusion.

This example method is illustrated in FIG. 10. At block 1002, a source femtocell may receive a first timing characteristic of a first femtocell, such as a target femtocell, from a first UE. Next, at block 1004, the source femtocell may receive a second timing characteristic associated with a second femtocell, which may likewise be a target femtocell and may exhibit the same PSC as the first femtocell, from a second UE. Thereafter, the source femtocell may compute first and second relative timing characteristics associated with first and second femtocells by comparing the first and second timing characteristics to a timing characteristic native to the source femtocell at blocks 1006 and 1008, respectively. By comparing these first and second relative timing characteristics at block 1010, the source femtocell may determine that PSC confusion exists where the two relative timing characteristics differ at block 1012.

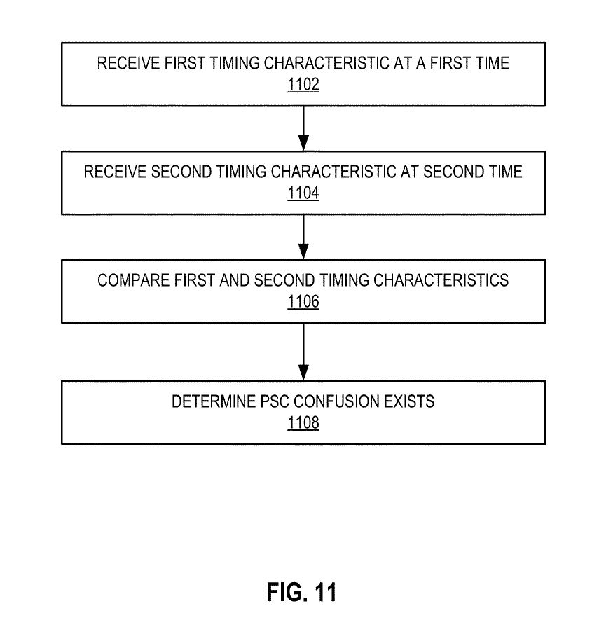

Referring now to FIG. 11, a source femtocell may maintain a history of target femtocell determinations, and, using these previous determinations for comparison with a current target femtocell determination, may determine that PSC confusion exists. In an aspect, a source femtocell may receive a first timing characteristic associated with a PSC at a first time at block 1102. Next, at block 1104, the source femtocell may receive a second timing characteristic associated with the PSC at a second time. In an aspect, the second time is subsequent to the first time. At block 1106, the source femtocell or other network device capable of comparison connected to the source femtocell, such as the gateway, may compare the first timing characteristic and the second timing characteristic. In an aspect the comparison may result in a determination that timing associated with a PSC has changed, and therefore the first and second timing characteristics must be associated with two separate target femtocells that share the same PSC. As a result, at block 1108, the source femtocell may determine that PSC confusion exists where the first timing characteristic is different than the second timing characteristic.

FIG. 12 illustrates another approach for recognizing PSC confusion. To remedy this problem of incorrect UE handover between femtocells, the source femtocell may wish to determine that the first target femtocell and the second target femtocell are in PSC confusion via the method of FIG. 12. The source femtocell may make this determination by maintaining a ratio of failed handovers for a given PSC to total handovers attempted to the given PSC. If this ratio exceeds a threshold value, the source femtocell may determine that PSC confusion exists on the network with respect to the given PSC.

Therefore, in an aspect, at block 1202, a source femtocell may maintain a first parameter representing a number of failed handovers associated with a PSC. Likewise, at block 1204, the source femtocell may maintain a second parameter representing a total number of attempted handovers associated with the PSC. From these parameters, the source femtocell (or other network device such as a gateway) may compute a failed handover ratio at block 1206. After this computation, the source femtocell may determine that PSC confusion exists where the failed handover ratio exceeds a threshold value at block 1208.

FIG. 13 illustrates sample operations that may be performed in accordance with the teachings herein to resolve physical layer identifier confusion. These operations may be performed, for example, by a gateway (e.g., a HNB-GW), a femtocell, or some other entity.

At block 1302, a gateway may receive at least one femtocell signature OTD (ARefOTD) from at least one femtocell in a wireless network environment. The gateway may store these at least one femtocell signature OTDs in a database that may be internal to a memory associated with the gateway. Next, at blocks 1304 and 1306, respectively, a gateway may receive a first and second OTD associated with a first and second target femtocell, respectively, which may be reported by a user equipment (UE). Then, at block 1308, a gateway may compute a femtocell signature OTD difference (ΔRefOTD), which may be the difference in signature OTDs reported by two femtocells at, for example, bootup. Furthermore, the gateway may compute an OTD difference (ΔOTD), which may be the difference between first and second OTDs, which may be associated with two or more target femtocells in PSC confusion, at block 1310. Thereafter, the gateway (or other network device) may compare these computed values (ΔRefOTD, ΔOTD) to match the observed ΔOTD to a stored ΔRefOTD to ascertain the identity of one or more target OTDs at block 1312. Through the use of this method, PSC confusion may be resolved, and a UE may be handed-over to a correct target femtocell, as the source femtocell or gateway has correctly resolved a TargetID field associated with the correct target femtocell.

In addition, in an aspect, a femtocell, such as a source macrocell, may report at least one neighboring macrocell to the gateway, which may store a neighboring macrocell for each femtocell in a wireless communication environment. These neighboring macrocells may be on the same or different frequency as a home macrocell, or could belong to the same or a different operator. In an example method for PSC confusion disambiguation, a UE may detect, for example, a beacon or pilot signal of a target femtocell in the wireless communication environment. This UE may detect a timing characteristic associated with the target femtocell, and may report this timing characteristic, which may comprise a clock difference, to a source femtocell currently serving the UE. Upon receipt, the source femtocell may send the timing characteristic to the gateway, which may store the timing characteristic associated with the target femtocell. In the report to the gateway, the source femtocell may fill a target identification field (TargetID) with a neighboring cell ID or the source node's own ID because the gateway may know the neighboring macrocells of each femtocell.

Therefore, in this example method there are two ways the gateway can ascertain the correct femtocell if PSC confusion exists. First, a source femtocell may populate the TargetID field with neighboring macrocell IDs. This may be communicated, for example, by a proprietary message. The gateway may receive this information for one or more macrocells under its control, and may then narrow down the list of possible correct target femtocells by knowing neighboring macrocell information.

Alternatively or additionally, a femtocell may provide its own cell ID to the gateway, and because the gateway has knowledge of all of the neighboring macrocells of a source femtocell, a correct femtocell identity may be derived from this information.

The teachings herein are applicable to various types of communication systems and may be implemented with various modifications. For example, although some of the above examples refer to UMTS technology, similar signaling and operations may be employed in other wireless technologies to achieve results similar to those discussed herein. Also, although some of the above examples refer to femtocells to femtocell handover, the teachings here may be applicable to other types of handovers. For example, the above techniques may be used for macrocell to femtocell handover. In this case, the cell identifier sent by a source macro access point to a gateway (e.g., HNB-GW) may comprise a macrocell identifier associated with the macro access point. In addition, the teachings herein may be used in a dedicated femtocell deployment (e.g., that uses a dedicated channel for the femtocells) or a non-dedicated deployment (e.g., where macrocells and femtocells may share a channel).

The teachings herein may be applicable to operations that do not involve handover. For example, operations similar to those describe above may be used to identify a problematic physical layer identifier (e.g., a PSC associated with reliability issues). In addition, appropriate action may be taken upon detecting a problematic identifier. For example, a femtocell may avoid camping on any femtocell that uses a PCS deemed to be problematic.

The teachings herein may be applicable to implementations that do not detect handover. For example, the timing information (e.g., OTDs) described above may be acquired and sent to a gateway (or other entity) irrespective of whether an attempt is made to detect confusion. In such a case, the gateway (or other entity) may use the reported timing information to identify the appropriate candidate for handover. As another example, in some cases, only the gateway or other entity (and not the serving femtocell) may determine whether there is confusion. In this case, the gateway (or other entity) may use the reported timing information to resolve the confusion, as needed.

It should be appreciated that various types of operations based on the teachings herein may be employed in a given implementation. Several examples follow.

In some implementations, a method of wireless communication comprises: sending messages employing a first handover protocol to a network entity to handover access terminals (e.g., UE) to at least one cell; determining whether a first femtocell and a second femtocell use the same physical layer identifier (e.g., primary scrambling code or physical cell identifier); and if the first and second femtocells use the same physical layer identifier, sending a message employing a second handover protocol to the network entity to handover an access terminal to the first femtocell or the second femtocell. In some aspects, the second handover protocol involves sending information in the message that is indicative of observed timing differences associated with the first femtocell and the second femtocell. In some aspects, the second handover protocol involves sending information in the message that identifies a macro cell or that identifies a source femtocell for handover of an access terminal to the first femtocell or the second femtocell. In some aspects, the determination of whether the first and second femtocells use the same physical layer identifier comprising determining whether received signals comprising the physical layer identifier are associated with different timing. In some aspects, the determination of whether the first and second femtocells use the same physical layer identifier comprising determining that a value based on a quantity of handover failures associated with the physical layer identifier meets or exceeds a threshold.

In some implementations, a method for recognizing Primary Scrambling Code (PSC) confusion includes: detecting a first timing characteristic of a first femtocell; receiving a second timing characteristic of a second femtocell from a user equipment (UE), wherein the first femtocell has the same PSC as the second femtocell; comparing the first timing characteristic and the second timing characteristic; and determining PSC confusion exists where the first timing characteristic is different than the second timing characteristic.

In some implementations, a method for recognizing Primary Scrambling Code (PSC) confusion includes: receiving a first timing characteristic of a first femtocell from a first UE; receiving a second timing characteristic of a second femtocell from a second UE, wherein the first femtocell and the second femtocell have the same PSC; computing a first relative timing characteristic by comparing the first timing characteristic to a native timing characteristic; computing a second relative timing characteristic by comparing the second timing characteristic to the native timing characteristic; comparing the first relative timing characteristic and the second relative timing characteristic; and determining PSC confusion exists where the first relative timing characteristic is different than the second relative timing characteristic.

In some implementations, a method for recognizing Primary Scrambling Code (PSC) confusion includes: receiving a first timing characteristic associated with a PSC at a first time; receiving a second timing characteristic associated with the PSC at a second time, wherein the second time is subsequent to the first time; comparing the first timing characteristic and the second timing characteristic; and determining PSC confusion exists where the first timing characteristic is different than the second timing characteristic.

In some implementations, a method for recognizing Primary Scrambling Code (PSC) confusion includes: maintaining a first parameter representing the number of failed handovers associated with a PSC; maintaining a second parameter representing the total number of handovers associated with the PSC; computing a failed handover ratio; and determining PSC confusion exists where the failed handover ratio exceeds a threshold value.

In some implementations, a method for PSC confusion disambiguation includes: receiving, at a gateway, at least one femtocell signature Observed Time Difference (OTD) from at least one femtocell; receiving a first OTD associated with a first femtocell reported by a user equipment (UE); receiving a second OTD associated with a second femtocell reported by the UE, wherein the first femtocell and the second femtocell are in PSC confusion; computing a femtocell signature OTD difference, wherein the femtocell signature OTD difference is defined as the difference between a first femtocell signature OTD associated with the first femtocell and a second femtocell signature OTD associated with the second femtocell; computing an OTD difference, wherein the OTD difference is defined as the difference between the first OTD and the second OTD; and matching the femtocell signature OTD difference to the OTD difference to ascertain an identity of at least one of the first femtocell and the second femtocell.

Further contemplated by the present disclosure is at least one processor configured to recognize PSC confusion and/or resolve PSC confusion, which includes a plurality of modules for implementing the above-described methods and method steps. In addition, the present disclosure provides for a computer program product, which may include a computer-readable medium, which may include one or more sets of codes for causing a computer to perform any of the methods or method steps described above. Additionally, the present disclosure contemplates an apparatus, which includes means for performing any of the methods or method steps introduced above. Moreover, the present disclosure contemplates an apparatus that includes physical and electrical components and/or modules that perform the above methods and/or method steps.

FIG. 14 illustrates several sample components (represented by corresponding blocks) that may be incorporated into an apparatus 1402 or an apparatus 1404 (e.g., corresponding to the access point 104 or the network entity 110 of FIG. 1, respectively) to perform identifier confusion-related operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatus 1402 to provide similar functionality. Also, a given node may contain one or more of the described components. For example, an apparatus may include multiple transceiver components that enable the apparatus to operate on multiple carriers and/or communicate via different technologies.

The apparatus 1402 includes at least one communication component 1406 (e.g., at least one wireless transceiver) for communicating with other nodes via at least one designated radio access technology. The communication component 1406 includes at least one transmitter 1412 for transmitting signals (e.g., messages, indications, information, and so on) and at least one receiver 1414 for receiving signals (e.g., messages, indications, information, and so on). In some embodiments, a communication component (e.g., one of multiple wireless communication devices) of the apparatus 1402 comprises a network listen module.

The apparatus 1402 and the apparatus 1404 each include one or more communication components 1408 and 1410 (e.g., one or more network interfaces), respectively, for communicating with other nodes (e.g., other network entities). For example, the communication components 1408 and 1410 may be configured to communicate with one or more network entities via a wire-based or wireless backhaul or backbone. In some aspects, the communication components 1408 and 1410 may be implemented as a transceiver configured to support wire-based or wireless communication. This communication may involve, for example, sending and receiving: messages, parameters, other types of information, and so on. Accordingly, in the example of FIG. 14, the communication component 1408 is shown as comprising a transmitter 1416 for sending signals and a receiver 1418 for receiving signals. Similarly, the communication component 1410 is shown as comprising a transmitter 1420 for sending signals and a receiver 1422 for receiving signals.

The apparatus 1402 also includes other components that may be used in conjunction with identifier confusion-related operations as taught herein. For example, the apparatus 1402 includes a processing system 1424 for providing functionality relating to detecting confusion and responding thereto and for providing other processing functionality. Similarly, the apparatus 1404 includes a processing system 1426 for providing functionality relating to detecting confusion and responding thereto and for providing other processing functionality. Each of the apparatuses 1402 or 1404 includes a respective memory component 1428 or 1430 (e.g., each including a memory device) for maintaining information (e.g., information, thresholds, parameters, and so on). In addition, each apparatus 1402 or 1404 includes a user interface device 1432 or 1434 for providing indications (e.g., audible and/or visual indications) to a user and/or for receiving user input (e.g., upon user actuation of a sensing device such a keypad, a touch screen, a microphone, and so on).

For convenience, the apparatuses 1402 and 1404 are shown in FIG. 14 as including components that may be used in the various examples described herein. In practice, the illustrated blocks may have different functionality in different implementations. For example, in some implementations, the functionality of the block 1424 or 1426 may be different in an embodiment that supports the scheme of FIG. 5 as compared to an embodiment that supports the scheme of FIG. 6.

The components of FIG. 14 may be implemented in various ways. In some implementations, the components of FIG. 14 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1406, 1408, 1424, 1428, and 1432 may be implemented by processor and memory component(s) of the apparatus 1402 (e.g., by execution of appropriate code and/or by appropriate configuration of processor components). Similarly, some or all of the functionality represented by blocks 1410, 1426, 1430, and 1434 may be implemented by processor and memory component(s) of the apparatus 1404 (e.g., by execution of appropriate code and/or by appropriate configuration of processor components).

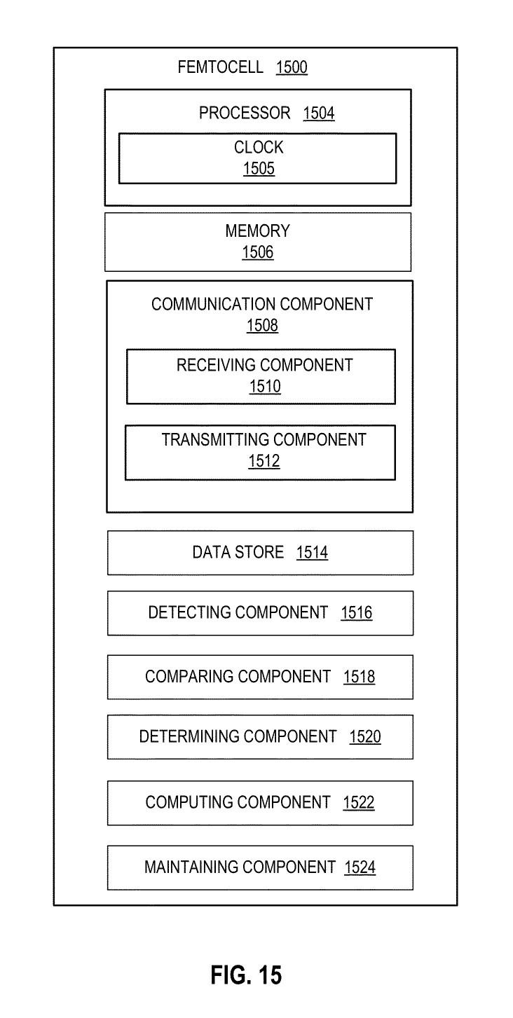

Referring to FIG. 15, in some aspects, any of devices 304, 312, 314 (FIG. 3), or any other femtocell described herein may be represented by a femtocell 1500. The femtocell 1500 includes a processor 1504 for carrying out processing functions associated with one or more of components and functions described herein. The processor 1504 can include a single or multiple set of processors or multi-core processors. Moreover, the processor 1504 can be implemented as an integrated processing system and/or a distributed processing system.

The femtocell 1500 further includes a memory 1506, such as for storing data used herein and/or local versions of applications being executed by processor 1504. The memory 1506 can include any type of memory usable by a computer, such as random access memory (RAM), read only memory (ROM), tapes, magnetic discs, optical discs, volatile memory, non-volatile memory, and any combination thereof.

Additionally, the processor 1504 may contain at least one clock 1505, which may control the timing of chip-level operations internal to the femtocell 1500 and may also control femtocell signal synchronization with other devices in a wireless communication environment, such as other femtocells or a macrocell. When the femtocell 1500 powers up, one or more of the at least one clocks will exhibit some relative clock frequency offset relative to a neighboring macrocell (and, naturally, other femtocells). Because of the high resolution of the clocks typically implemented in wireless network devices, this offset has a high likelihood of being unique to a single femtocell 1500 in a network. As such, this relative clock offset may serve as a signature timing characteristic for each femtocell in a wireless communication environment. Thus, this unique signature timing characteristic may serve as an identifier of a femtocell 1500 to other femtocells or devices in the wireless communication environment.

Further, the femtocell 1500 includes a communication component 1508 that provides for establishing and maintaining communication with one or more parties utilizing hardware, software, and services as described herein. The communication component 1508 may carry communication between components on the femtocell 1500, as well as between the femtocell 1500 and external devices, such as devices located across a communication network, wireless communication environment 300 (FIG. 3) and/or devices serially or locally connected to the femtocell 1500 via OTA links, communication channels, tethered connections, or any other means of electronic power or data exchange, such as, but not limited to, other femtocells, the gateway 316, the Internet 318, the macrocell 322, or any other device located in a wireless communication environment. For example, the communication component 1508 may include one or more buses, and may further include transmit chain components and receive chain components associated with a transmitter and a receiver, respectively, operable for interfacing with external devices.

Furthermore, the femtocell 1500 may include a receiving component 1510, which may be located inside the communication component 1508. Alternatively, the receiving component 1510 may be located external to the communication component 1508 or the femtocell 1500 and connected to these components via a tethered or wireless connection. The receiving component 1510 may be operable to receive signals over the air from one or more femtocells or UEs. For example, the receiving component 1510 may receive a first timing characteristic from a first femtocell, a second timing characteristic from a second femtocell or UE, a timing beacon from a macrocell or any macro network device, any other timing signal from any other device in wireless communication environment 300, or any other electrical communication from any device connected to the femtocell 1500 via a communication link. Additionally, the receiving component 1510 may include a receiver or a transceiver.

Furthermore, the femtocell 1500 may include a transmitting component 1512, which may be located inside the communication component 1508. Alternatively, the transmitting component 1512 may be located external to the communication component 1508 or the femtocell 1500 and connected to these components via a tethered or wireless connection. The transmitting component 1512 may be operable to send tethered or wireless communication signals to other devices in the wireless communication environment 300. For example, the transmitting component 1512 may send information over a tethered connection of in the form of an OTA message over a wireless link or channel to other femtocells or the gateway 316. Specifically, the transmitting component 1512 may send timing information or timing characteristics, such as an Observed Time Difference (OTD) to other femtocells. Also, the transmitting component 1512 may periodically send a beacon signal through the air to alert devices of its presence in a wireless communication environment. Additionally, the transmitting component 1512 may include a transmitter or a transceiver.

Additionally, the femtocell 1500 may further include a data store 1514, which can be any suitable combination of hardware and/or software, which provides for mass storage of information, databases, and programs employed in connection with aspects described herein. For example, the data store 1514 may be a data repository for applications not currently being executed by the processor 1504.

In addition, the femtocell 1500 may include a detecting component 1516, which may detect a timing characteristic associated with one or more other femtocells or macro network components, including neighboring macrocells. After detection of a timing characteristic, the detecting component 1516 may send the timing characteristic to the memory 1506 or the data store 1514, or may forward this information, along with an identification, such as a PSC, of the device with which the timing characteristic is associated. Additionally or alternatively, the detecting component 1516 may forward a timing characteristic and identification to the gateway 316.

Furthermore, the femtocell 1500 may include a comparing component 1518, which may be operable to compare a received or native timing characteristic to a timing characteristic associated with another femtocell, macrocell, or other device. Additionally or alternatively, the comparing component 1518 may compare a timing characteristic of another femtocell to the native timing characteristic, which may also be referred to as a signature timing characteristic, associated with the femtocell 1500. Algorithms, software, hardware, or other components or items stored in the processor 1504, the memory 1506, the data store 1514 may be utilized by the comparing component 1518 to execute comparing operations.

Additionally, the femtocell 1500 may include a determining component 1520, which may determine if PSC confusion exists with respect to other femtocells in a wireless communication environment. To make this determination, the determining component 1520 may utilize timing characteristic values received from or stored in other femtocells, macrocells, gateways, or any other device in a wireless network or the wireless communication environment 300 or external to the wireless network or the wireless communication environment 300. Additionally, the determining component 1520 may determine that PSC confusion exists when a PSC confusion ratio threshold is exceeded. Furthermore, algorithms, software, hardware, or other components or items stored in the processor 1504, the memory 1506, the data store 1514 may be utilized by the determining component 1520 to execute determination operations.

In addition, the femtocell 1500 may include a computing component 1522, which may compute relative timing characteristics that may be based upon comparing timing characteristics computed or received from one or more other devices, such as, but not limited to other femtocells, macrocell devices, or other components on the femtocell 1500. In addition, the computing component 1522 may compute a failed handover ratio associated with handover of a UE between femtocells in a wireless communication environment 300. The computing component 1522 may be located internal to the processor 1504 or may be located external to the processor 1504 or external to the femtocell 1500 and communicatively connected to the femtocell 1500 by a tethered or wireless connection. To execute computing operations, the computing component 1522 may utilize timing characteristic values received from or stored in other femtocells, macrocells, gateways, or any other device in a wireless network or the wireless communication environment 300 or external to the wireless network or the wireless communication environment 300. Furthermore, algorithms, software, hardware, or other components or items stored in the processor 1504, the memory 1506, the data store 1514 may be utilized by the computing component 1522 to execute computations or comparison operations.

Additionally, the femtocell 1500 may include a maintaining component 1524 for maintaining parameters associated with the number of failed handovers associated with particular PSCs and the number of total handovers associated with particular PSCs. In an aspect, the maintaining component 1524 may be located in the memory 1506, the data store 1514, or any other data cache located on a device internal or external to the wireless communication environment 300. Additionally, the maintaining component 1524 may supply the above parameters to the computing component 1522, which may compute a failed handover ratio, which may be defined as a ratio of the number of failed handovers associated with a particular PSC to the number of total handovers attempted by one or more femtocells.

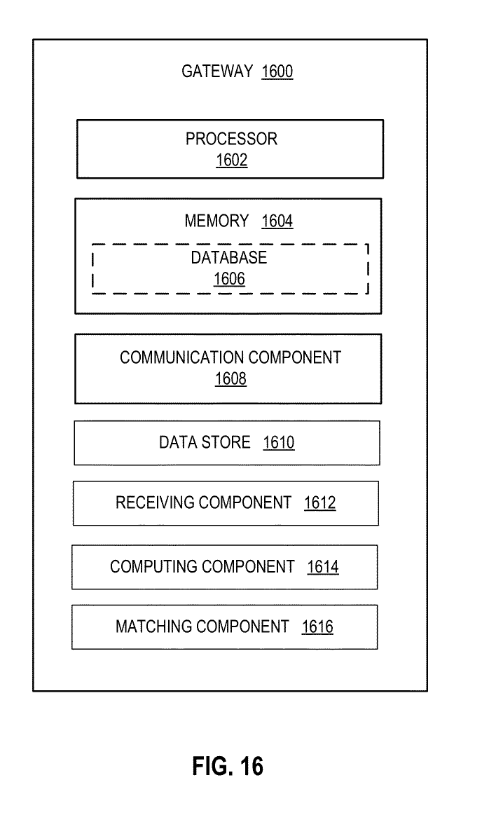

Referring to FIG. 16, in some aspects, a gateway 1600 that may control and service a plurality of femtocells is illustrated. Additionally, the gateway 1600 may interface this plurality of femtocells with a core network, the Internet, or another wireless or core network device. The gateway 1600 includes a processor 1602 for carrying out processing functions associated with one or more of components and functions described herein. The processor 1602 can include a single or multiple set of processors or multi-core processors. Moreover, the processor 1602 can be implemented as an integrated processing system and/or a distributed processing system. Furthermore, the processor 1602 may be connected to or may include a computing component 1614 for comparing received timing characteristic values and/or differences.

The gateway 1600 further includes a memory 1604, such as for storing data used herein and/or local versions of applications being executed by the processor 1602. The memory 1604 can include any type of memory usable by a computer, such as random access memory (RAM), read only memory (ROM), tapes, magnetic discs, optical discs, volatile memory, non-volatile memory, and any combination thereof. Furthermore, the gateway 1600 may include a database 1606, which may be internal to the memory 1604. The database 1606 may be operable to store parameter values and associate these parameter values with one or more wireless communication devices. For example, the database 1606 may maintain Observed Time Difference values associated with one or more femtocells in the wireless communication environment 300 (FIG. 3).

Further, the gateway 1600 includes a communication component 1608 that provides for establishing and maintaining communication with one or more parties utilizing hardware, software, and services as described herein. The communication component 1608 may carry communication between components on the gateway 1600, as well as between the gateway 1600 and external devices, such as devices located across a communication network and/or devices serially or locally connected to the gateway 1600. For example, the gateway 1600 may include one or more buses, and may further include transmit chain components and receive chain components associated with a transmitter and a receiver, respectively, operable for interfacing with external devices.

Additionally, the gateway 1600 may further include a data store 1610, which can be any suitable combination of hardware and/or software, that provides for mass storage of information, databases, and programs employed in connection with aspects described herein. For example, the data store 1610 may be a data repository for applications not currently being executed by the processor 1602.

In addition, the gateway 1600 may include a receiving component 1612, which may be operable to receive one or more OTD from at least one femtocell. In an example, this OTD may be a signature OTD or an OTD associated with a target femtocell, and may be reported by a source femtocell, a target femtocell, and/or a UE present in a wireless communication environment. Additionally, the receiving component 1612 may be internal to the communication component 1608, and may be, for example, a receiver or a transceiver.

Furthermore, the gateway 1600 may include a computing component 1614, which may be operable to compute a signature OTD difference and/or an OTD difference from timing characteristics reported to the gateway 1600 and maintained in the memory 1604, the database 1606, and/or the data store 1610. The computing component 1614 may be internal to the processor 1602, or may be located elsewhere in the gateway 1600 or on another device connected to the gateway 1600. In addition, algorithms, software, hardware, or other components or items stored in the computing component 1614, the processor 1602, the memory 1604, the data store 1610 may be utilized by the computing component 1614 to execute computing operations.

In addition, the gateway 1600 may include a matching component 1616 for matching a signature OTD difference to an OTD difference to ascertain an identity of at least one target femtocell. The matching component 1616 may be connected to the memory 1604, the database 1606, and/or the data store 1610, which may provide OTD and/or OTD difference values to the matching component 1616 for matching. In an aspect, the matching component 1616 may match a OTD and/or OTD difference values by ascertaining a TargetID value for correct target femtocell population of at least one UE.

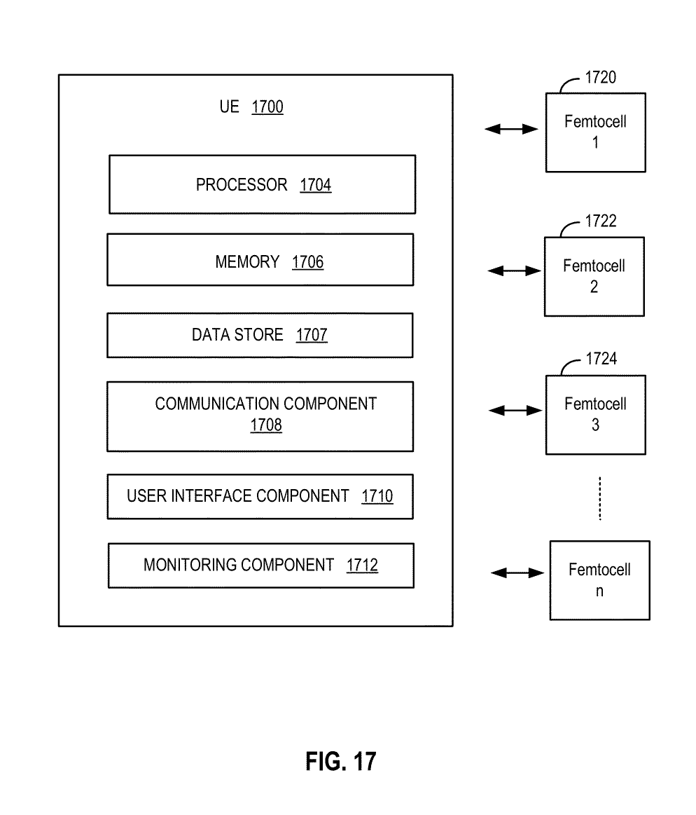

Referring to FIG. 17, in some aspects, a UE 1700 is shown, which may communicate with one or more femtocells (e.g., femtocells 1-n, such as femtocells 1720, 1722, 1724, etc.) or other network devices in a wireless communication environment, such as a gateway (e.g., gateway 316 in FIG. 3). In an aspect, the UE 1700 has the functionality to communicate via several communicative channels that may be associated with different femtocells, macrocells, or other devices in a wireless communication environment. The UE 1700 may include a processor 1704 for carrying out processing functions associated with one or more of components and functions described herein. The processor 1704 can include a single or multiple set of processors or multi-core processors. Moreover, the processor 1704 can be implemented as an integrated processing system and/or a distributed processing system.

The UE 1700 further includes a memory 1706, such as for storing data used herein and/or local versions of applications being executed by the processor 1704. The memory 1706 can include any type of memory usable by a computer, such as random access memory (RAM), read only memory (ROM), tapes, magnetic discs, optical discs, volatile memory, non-volatile memory, and any combination thereof.

Additionally, the UE 1700 may further include a data store 1707, which can be any suitable combination of hardware and/or software that provides for mass storage of information, databases, and programs employed in connection with aspects described herein. For example, the data store 1707 may be a data repository for applications not currently being executed by the processor 1704.

Further, the UE 1700 may include a communication component 1708 that provides for establishing and maintaining communication with one or more femtocells or other network devices utilizing hardware, software, and services as described herein, such as a macrocell or gateway. The communication component 1708 may carry communication between components on the UE 1700, as well as between the UE 1700 and external devices, such as macrocell devices (e.g., base stations) or other devices located across a communication network or wireless communication environment and/or devices serially or locally connected to the UE 1700 or femtocells (e.g., femtocells 1-n, such as femtocells 1720, 1722, or 1724) or other network devices in a wireless communication environment, such as a gateway (e.g., the gateway 316 in FIG. 3), or a core network such as the Internet or the Public Switch Telephone Network (PSTN). For example, the communication component 1708 may include one or more buses, and may further include transmit chain components and receive chain components associated with a transmitter and receiver, respectively, operable for interfacing with external devices. Additionally, the communication component 1708 may provide for establishing communication channels with one or more femtocells or macrocells based on a command from a first femtocell or macrocell to establish such a communicative connection with a second, third, or n-th femtocell or base station.

The UE 1700 may additionally include a user interface component 1710 operable to receive inputs from a user of the UE 1700, and further operable to generate outputs for presentation to the user. The user interface component 1710 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, the user interface component 1710 may include one or more output devices, including but not limited to a display, a speaker, a haptic feedback mechanism, a printer, any other mechanism capable of presenting an output to a user, or any combination thereof.

Additionally the UE 1700 may include a monitoring component 1712 for measuring communication conditions on one or more femtocells base stations (e.g., femtocells 1-n, such as femtocells 1720, 1722, or 1724) within communicative range of the UE 1700 or in a UE active set. Additionally, monitoring component may also ascertain a PSC associated with one or more femtocell, such as a target femtocell to which the UE may seek to transfer during a handover. The monitoring component 1712 may transfer these PSC values to the communication component 1708 for forwarding to a source femtocell for eventual use in handover, PSC confusion recognition or disambiguation, or other functions disclosed herein.

In an aspect, the monitoring component 1712 may continuously monitor a wireless network environment for available femtocells or macrocells (e.g., base stations) within its communicative range and may add one or more femtocells or macrocells to an active set associated with a UE when the one or more base stations are available for communication. Thereafter, in an aspect, the UE may monitor each femtocell (e.g., femtocells 1-n, such as femtocells 1720, 1722, or 1724) or other network devices in a wireless communication environment, such as a macrocell (e.g. base station) in its active set, or any combination of serving and/or neighbor femtocells or macrocells, on each service area or cell associated with one or more previously-established communication channels to determine communication conditions for various frequencies associated with each femtocell or macrocell. In an aspect, the monitoring component 1712 may compile the results of the monitoring and may send the results to a femtocell, gateway, or macrocell in a measurement report. Alternatively or additionally, the monitoring component 1712 may save the results of the monitoring in the memory 1706 and/or data store the 1707 for later use. Furthermore, the monitoring component 1712 may be communicatively connected to the processor 1704, which may provide calculations and/or processing support for generating the measurement report to be sent to a base station or stored on the UE.

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

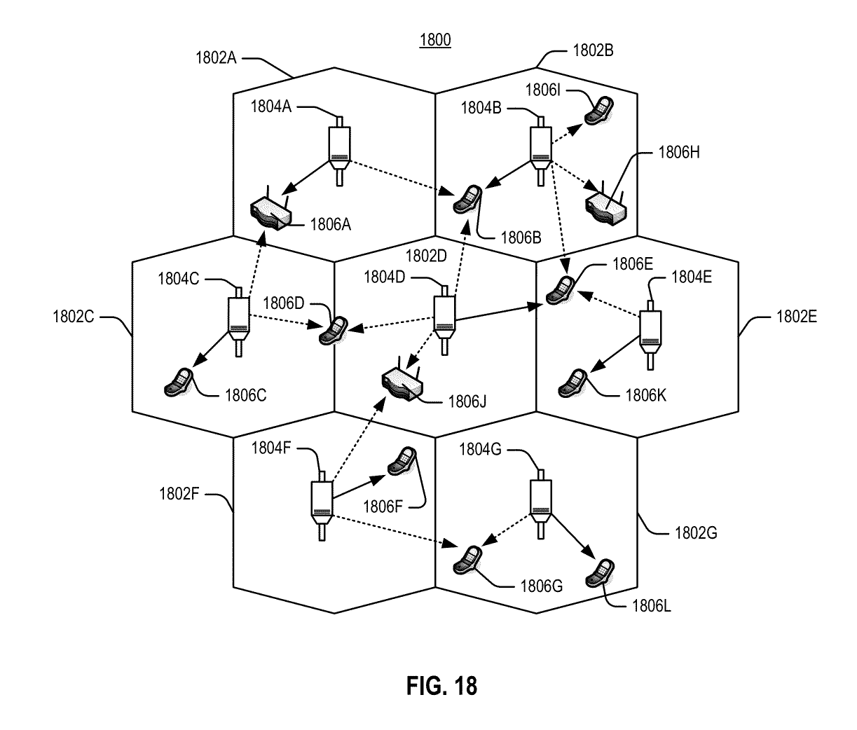

FIG. 18 illustrates a wireless communication system 1800, configured to support a number of users, in which the teachings herein may be implemented. The system 1800 provides communication for multiple cells 1802, such as, for example, macro cells 1802A-1802G, with each cell being serviced by a corresponding access point 1804 (e.g., access points 1804A-1804G). As shown in FIG. 18, access terminals 1806 (e.g., access terminals 1806A-1806L) may be dispersed at various locations throughout the system over time. Each access terminal 1806 may communicate with one or more access points 1804 on a forward link (FL) and/or a reverse link (RL) at a given moment, depending upon whether the access terminal 1806 is active and whether it is in soft handover, for example. The wireless communication system 1800 may provide service over a large geographic region. For example, macro cells 1802A-1802G may cover a few blocks in a neighborhood or several miles in a rural environment.

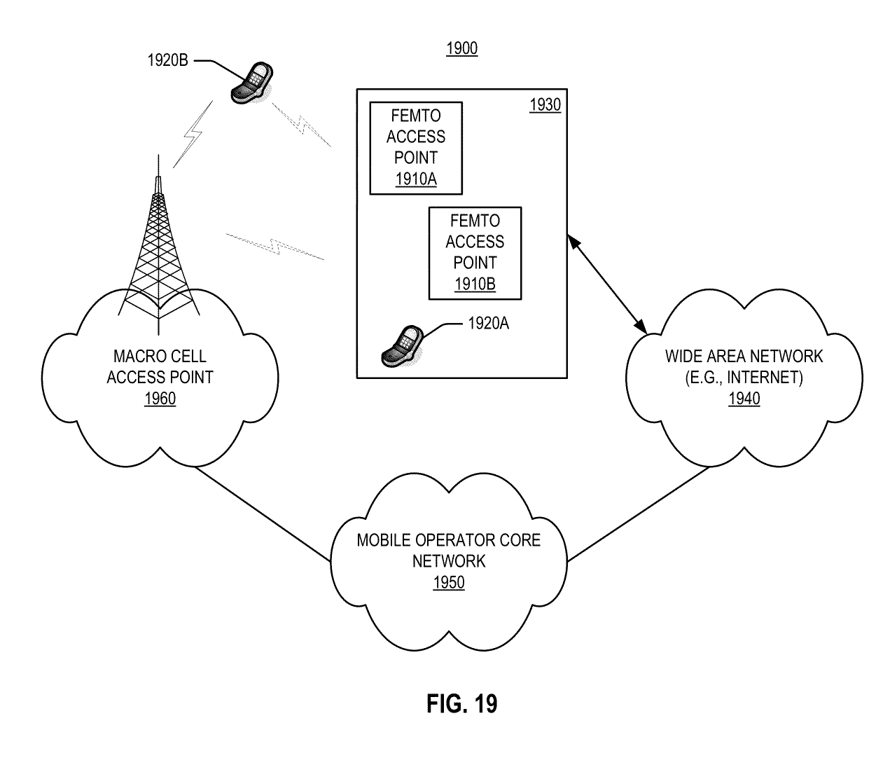

FIG. 19 illustrates an exemplary communication system 1900 where one or more femto access points are deployed within a network environment. Specifically, the system 1900 includes multiple femto access points 1910 (e.g., femto access points 1910A and 1910B) installed in a relatively small scale network environment (e.g., in one or more user residences 1930). Each femto access point 1910 may be coupled to a wide area network 1940 (e.g., the Internet) and a mobile operator core network 1950 via a DSL router, a cable modem, a wireless link, or other connectivity means (not shown). As will be discussed below, each femto access point 1910 may be configured to serve associated access terminals 1920 (e.g., access terminal 1920A) and, optionally, other (e.g., hybrid or alien) access terminals 1920 (e.g., access terminal 1920B). In other words, access to femto access points 1910 may be restricted whereby a given access terminal 1920 may be served by a set of designated (e.g., home) femto access point(s) 1910 but may not be served by any non-designated femto access points 1910 (e.g., a neighbor's femto access point 1910).

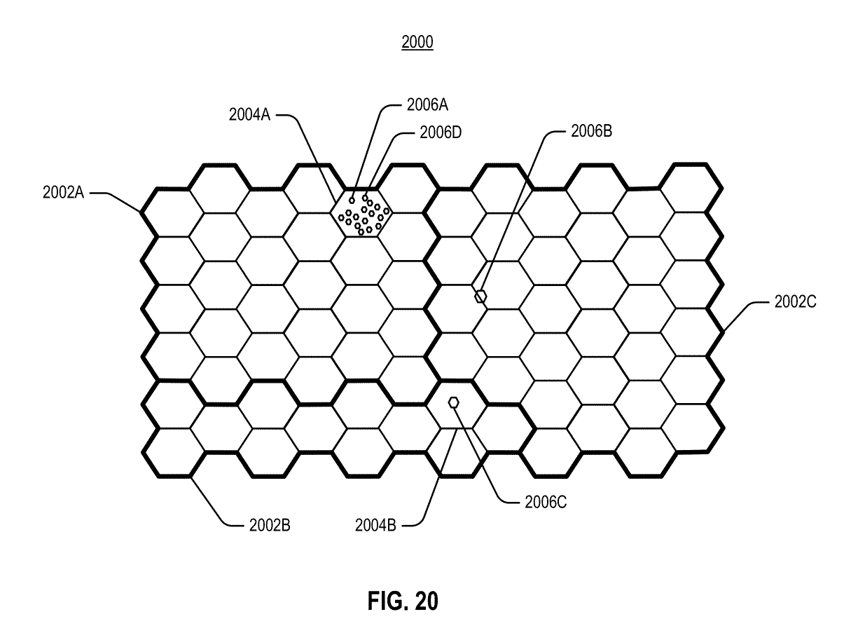

FIG. 20 illustrates an example of a coverage map 2000 where several tracking areas 2002 (or routing areas or location areas) are defined, each of which includes several macro coverage areas 2004. Here, areas of coverage associated with tracking areas 2002A, 2002B, and 2002C are delineated by the wide lines and the macro coverage areas 2004 are represented by the larger hexagons. The tracking areas 2002 also include femto coverage areas 2006. In this example, each of the femto coverage areas 2006 (e.g., femto coverage areas 2006B and 2006C) is depicted within one or more macro coverage areas 2004 (e.g., macro coverage areas 2004A and 2004B). It should be appreciated, however, that some or all of a femto coverage area 2006 may not lie within a macro coverage area 2004. In practice, a large number of femto coverage areas 2006 (e.g., femto coverage areas 2006A and 2006D) may be defined within a given tracking area 2002 or macro coverage area 2004. Also, one or more pico coverage areas (not shown) may be defined within a given tracking area 2002 or macro coverage area 2004.

Referring again to FIG. 19, the owner of a femto access point 1910 may subscribe to mobile service, such as, for example, 3G mobile service, offered through the mobile operator core network 1950. In addition, an access terminal 1920 may be capable of operating both in macro environments and in smaller scale (e.g., residential) network environments. In other words, depending on the current location of the access terminal 1920, the access terminal 1920 may be served by a macro cell access point 1960 associated with the mobile operator core network 1950 or by any one of a set of femto access points 1910 (e.g., the femto access points 1910A and 1910B that reside within a corresponding user residence 1930). For example, when a subscriber is outside his home, he is served by a standard macro access point (e.g., access point 1960) and when the subscriber is at home, he is served by a femto access point (e.g., access point 1910A). Here, a femto access point 1910 may be backward compatible with legacy access terminals 1920.

A femto access point 1910 may be deployed on a single frequency or, in the alternative, on multiple frequencies. Depending on the particular configuration, the single frequency or one or more of the multiple frequencies may overlap with one or more frequencies used by a macro access point (e.g., access point 1960).

In some aspects, an access terminal 1920 may be configured to connect to a preferred femto access point (e.g., the home femto access point of the access terminal 1920) whenever such connectivity is possible. For example, whenever the access terminal 1920A is within the user's residence 1930, it may be desired that the access terminal 1920A communicate only with the home femto access point 1910A or 1910B.

In some aspects, if the access terminal 1920 operates within the macro cellular network 1950 but is not residing on its most preferred network (e.g., as defined in a preferred roaming list), the access terminal 1920 may continue to search for the most preferred network (e.g., the preferred femto access point 1910) using a better system reselection (BSR) procedure, which may involve a periodic scanning of available systems to determine whether better systems are currently available and subsequently acquire such preferred systems. The access terminal 1920 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 1910, the access terminal 1920 selects the femto access point 1910 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 1910 that reside within the corresponding user residence 1930). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where N_{S}≦min{N_{T}, N_{R}}. Each of the Nₛ independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

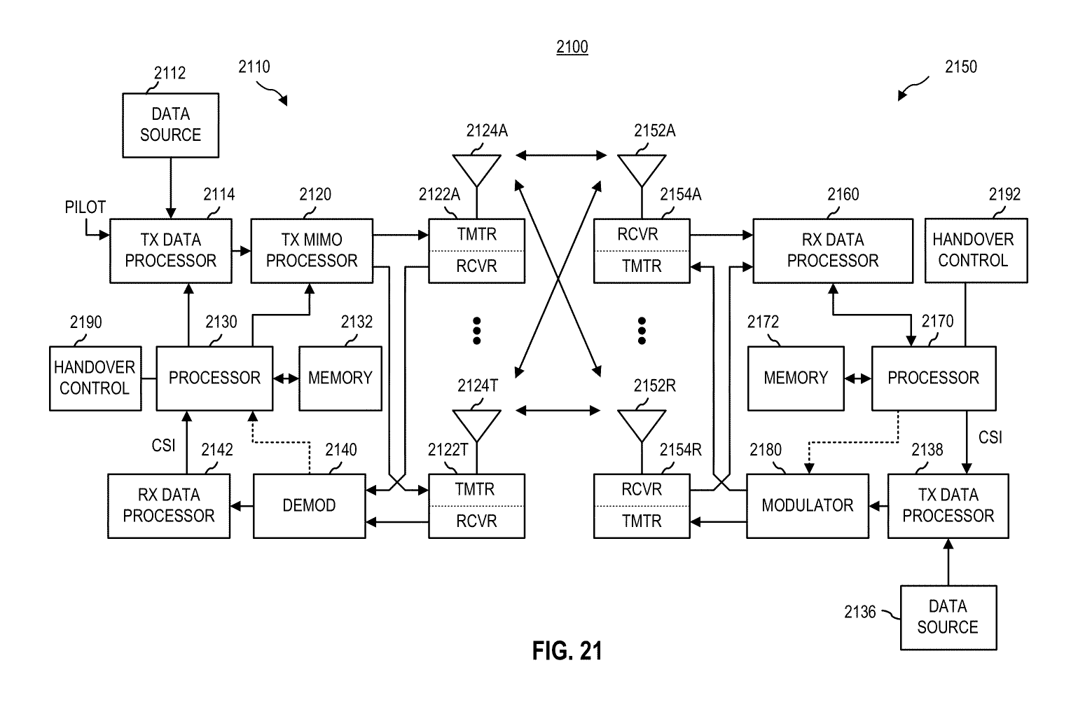

FIG. 21 illustrates a wireless device 2110 (e.g., an access point) and a wireless device 2150 (e.g., an access terminal) of a sample MIMO system 2100. At the device 2110, traffic data for a number of data streams is provided from a data source 2112 to a transmit (TX) data processor 2114. Each data stream may then be transmitted over a respective transmit antenna.

The TX data processor 2114 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 2130. A data memory 2132 may store program code, data, and other information used by the processor 2130 or other components of the device 2110.

The modulation symbols for all data streams are then provided to a TX MIMO processor 2120, which may further process the modulation symbols (e.g., for OFDM). The TX MIMO processor 2120 then provides N_{T} modulation symbol streams to N_{T} transceivers (XCVR) 2122A through 2122T. In some aspects, the TX MIMO processor 2120 applies beam-forming weights to the symbols of the data streams and to the antenna from which the symbol is being transmitted.

Each transceiver 2122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 2122A through 2122T are then transmitted from N_{T} antennas 2124A through 2124T, respectively.

At the device 2150, the transmitted modulated signals are received by N_{R} antennas 2152A through 2152R and the received signal from each antenna 2152 is provided to a respective transceiver (XCVR) 2154A through 2154R. Each transceiver 2154 conditions (e.g., filters, amplifies, and downconverts) a respective received signal, digitizes the conditioned signal to provide samples, and further processes the samples to provide a corresponding “received” symbol stream.

A receive (RX) data processor 2160 then receives and processes the N_{R} received symbol streams from N_{R} transceivers 2154 based on a particular receiver processing technique to provide N_{T} “detected” symbol streams. The RX data processor 2160 then demodulates, deinterleaves, and decodes each detected symbol stream to recover the traffic data for the data stream. The processing by the RX data processor 2160 is complementary to that performed by the TX MIMO processor 2120 and the TX data processor 2114 at the device 2110.

A processor 2170 periodically determines which pre-coding matrix to use (discussed below). The processor 2170 formulates a reverse link message comprising a matrix index portion and a rank value portion. A data memory 2172 may store program code, data, and other information used by the processor 2170 or other components of the device 2150.

The reverse link message may comprise various types of information regarding the communication link and/or the received data stream. The reverse link message is then processed by a TX data processor 2138, which also receives traffic data for a number of data streams from a data source 2136, modulated by a modulator 2180, conditioned by the transceivers 2154A through 2154R, and transmitted back to the device 2110.

At the device 2110, the modulated signals from the device 2150 are received by the antennas 2124, conditioned by the transceivers 2122, demodulated by a demodulator (DEMOD) 2140, and processed by a RX data processor 2142 to extract the reverse link message transmitted by the device 2150. The processor 2130 then determines which pre-coding matrix to use for determining the beam-forming weights then processes the extracted message.

FIG. 21 also illustrates that the communication components may include one or more components that perform handover control operations as taught herein. For example, a handover control component 2190 may cooperate with the processor 2130 and/or other components of the device 2110 to send/receive handover-related signals to/from another device (e.g., device 2150) as taught herein. Similarly, a handover control component 2192 may cooperate with the processor 2170 and/or other components of the device 2150 to send/receive handover-related signals to/from another device (e.g., device 2110). It should be appreciated that for each device 2110 and 2150 the functionality of two or more of the described components may be provided by a single component. For example, a single processing component may provide the functionality of the handover control component 2190 and the processor 2130 and a single processing component may provide the functionality of the handover control component 2192 and the processor 2170.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

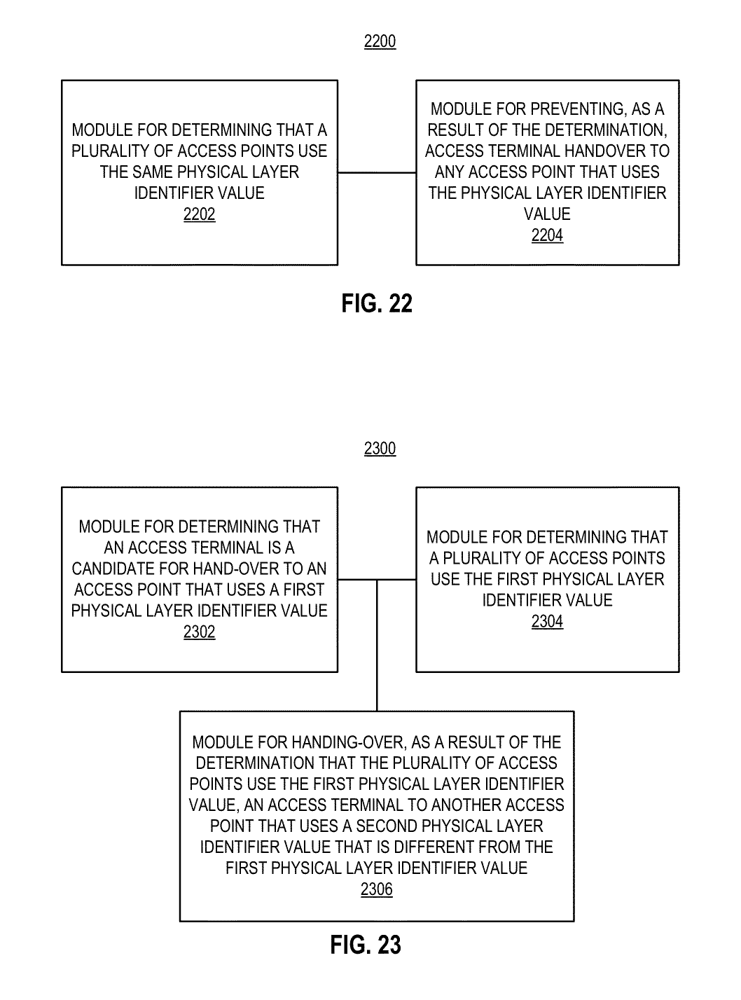

Referring to FIG. 22, an apparatus 2200 is represented as a series of interrelated functional modules. A module for (e.g., means for) determining that a plurality of access points use the same physical layer identifier value 2202 may correspond at least in some aspects to, for example, a processing system and/or a communication module as discussed herein. A module for (e.g., means for) preventing, as a result of the determination, access terminal handover to any access point that uses the physical layer identifier value 2204 may correspond at least in some aspects to, for example, a processing system and/or a communication module as discussed herein.

Referring to FIG. 23, an apparatus 2300 is represented as a series of interrelated functional modules. A module for (e.g., means for) determining that an access terminal is a candidate for hand-over to an access point that uses a first physical layer identifier value 2302 may correspond at least in some aspects to, for example, a processing system and/or a communication module as discussed herein. A module for (e.g., means for) determining that a plurality of access points use the first physical layer identifier value 2304 may correspond at least in some aspects to, for example, a processing system and/or a communication module as discussed herein. A module for (e.g., means for) handing-over, as a result of the determination that the plurality of access points use the first physical layer identifier value, an access terminal to another access point that uses a second physical layer identifier value that is different from the first physical layer identifier value 2306 may correspond at least in some aspects to, for example, a processing system and/or a communication module as discussed herein.

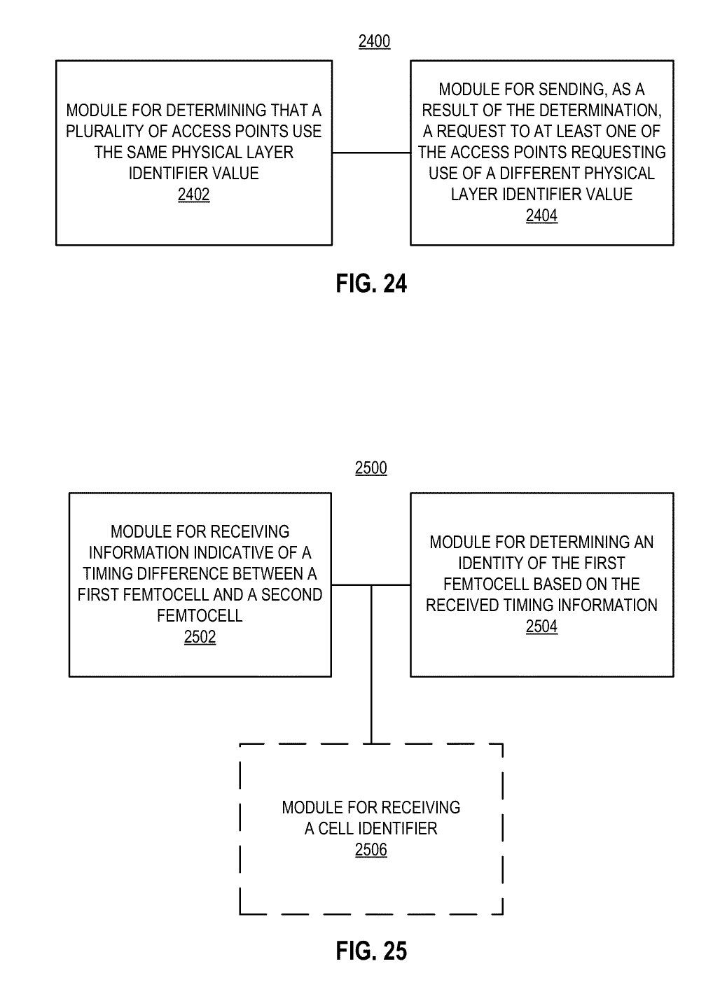

Referring to FIG. 24, an apparatus 2400 is represented as a series of interrelated functional modules. A module for (e.g., means for) determining that a plurality of access points use the same physical layer identifier value 2402 may correspond at least in some aspects to, for example, a processing system and/or a communication module as discussed herein. A module for (e.g., means for) sending, as a result of the determination, a request to at least one of the access points requesting use of a different physical layer identifier value 2404 may correspond at least in some aspects to, for example, a processing system and/or a communication module as discussed herein.

Referring to FIG. 25, an apparatus 2500 is represented as a series of interrelated functional modules. A module for (e.g., means for) receiving information indicative of a timing difference between a first femtocell and a second femtocell 2502 may correspond at least in some aspects to, for example, a processing system and/or a communication module as discussed herein. A module for (e.g., means for) determining an identity of the first femtocell based on the received timing information 2504 may correspond at least in some aspects to, for example, a processing system and/or a communication module as discussed herein. A module for (e.g., means for) receiving a cell identifier 2506 may correspond at least in some aspects to, for example, a processing system and/or a communication module as discussed herein.

The functionality of the modules of FIGS. 22-25 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. The functionality of these modules also may be implemented in some other manner as taught herein. In some aspects one or more of any dashed blocks in FIGS. 22-25 are optional.

In addition, the components and functions represented by FIGS. 22-25 as well as other components and functions described herein, may be implemented using any suitable means. Such means also may be implemented, at least in part, using corresponding structure as taught herein. For example, the components described above in conjunction with the “module for” components of FIGS. 22-25 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage media, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of wireless communication, comprising:
determining that a plurality of access points use the same physical layer identifier value; and
preventing, as a result of the determination, access terminal handover to any access point that uses the physical layer identifier value.

2. The method of claim 1, wherein the determination that the plurality of access points use the same physical layer identifier value comprises determining whether received signals comprising the physical layer identifier value are associated with different timing.

3. The method of claim 2, wherein the different timing comprises:
a first timing difference between a first one of the access points and a reference access point; and
a second timing difference between a second one of the access points and the reference access point.

4. The method of claim 3, wherein the reference access point is a serving access point.

5. The method of claim 3, wherein at least one of the first timing difference and the second timing difference is obtained using cell synchronization information.

6. The method of claim 1, wherein the determination that the plurality of access points use the same physical layer identifier value comprises determining that a value based on a quantity of handover failures associated with the physical layer identifier meets or exceeds a threshold.

7. The method of claim 1, wherein the physical layer identifier comprises a primary scrambling code or a physical cell identifier.

8. The method of claim 1, wherein each of the access points comprises a femtocell.

9. The method of claim 1, wherein the determination that the plurality of access points use the same physical layer identifier value comprises determining whether received signals comprising the physical layer identifier value are associated with different cell identities.

10. The method of claim 9, wherein cell identities are unique within a public land mobile network.

11. An apparatus for wireless communication, comprising:
a processing system configured to determine that a plurality of access points use the same physical layer identifier value; and
a communication component configured to prevent, as a result of the determination, access terminal handover to any access point that uses the physical layer identifier value.

12. The apparatus of claim 11, wherein the determination that the plurality of access points use the same physical layer identifier value comprises determining whether received signals comprising the physical layer identifier value are associated with different timing.

13. The apparatus of claim 12, wherein the different timing comprises:
a first timing difference between a first one of the access points and a reference access point; and
a second timing difference between a second one of the access points and the reference access point.

14. The apparatus of claim 13, wherein the reference access point is a serving access point.

15. The apparatus of claim 13, wherein at least one of the first timing difference and the second timing difference is obtained using cell synchronization information.

16. The apparatus of claim 11, wherein the determination that the plurality of access points use the same physical layer identifier value comprises determining that a value based on a quantity of handover failures associated with the physical layer identifier meets or exceeds a threshold.

17. The apparatus of claim 11, wherein the physical layer identifier comprises a primary scrambling code or a physical cell identifier.

18. The apparatus of claim 11, wherein each of the access points comprises a femtocell.

19. The apparatus of claim 11, wherein the determination that the plurality of access points use the same physical layer identifier value comprises determining whether received signals comprising the physical layer identifier value are associated with different cell identities.

20. The apparatus of claim 19, wherein cell identities are unique within a public land mobile network.

21. An apparatus for wireless communication, comprising:
means for determining that a plurality of access points use the same physical layer identifier value; and
means for preventing, as a result of the determination, access terminal handover to any access point that uses the physical layer identifier value.

22. The apparatus of claim 21, wherein the determination that the plurality of access points use the same physical layer identifier value comprises determining whether received signals comprising the physical layer identifier value are associated with different timing.

23. A computer-program product, comprising:
computer-readable medium comprising code for causing a computer to:
determine that a plurality of access points use the same physical layer identifier value; and
prevent, as a result of the determination, access terminal handover to any access point that uses the physical layer identifier value.

24. The computer-program product of claim 23, wherein the determination that the plurality of access points use the same physical layer identifier value comprises determining whether received signals comprising the physical layer identifier value are associated with different timing.

25. A method of wireless communication, comprising:
determining that an access terminal is a candidate for handover to an access point that uses a first physical layer identifier value;
determining that a plurality of access points use the first physical layer identifier value; and
handing-over, as a result of the determination that the plurality of access points use the first physical layer identifier value, the access terminal to another access point that uses a second physical layer identifier value that is different from the first physical layer identifier value.

26. The method of claim 25, wherein the determination that the plurality of access points use the first physical layer identifier value comprises determining whether received signals comprising the first physical layer identifier value are associated with different timing.

27. The method of claim 26, wherein the different timing comprises:
a first timing difference between a first one of the access points and a reference access point; and
a second timing difference between a second one of the access points and the reference access point.

28. The method of claim 27, wherein the reference access point is a serving access point.

29. The method of claim 27, wherein at least one of the first timing difference and the second timing difference is obtained using cell synchronization information.

30. The method of claim 25, wherein the determination that the plurality of access points use the first physical layer identifier value comprises determining that a value based on a quantity of handover failures associated with the first physical layer identifier meets or exceeds a threshold.

31. The method of claim 25, wherein the first and second physical layer identifiers comprise primary scrambling codes or physical cell identifiers.

32. The method of claim 25, wherein each of the access points comprises a femtocell.

33. The method of claim 25, wherein the determination that the plurality of access points use the first physical layer identifier value comprises determining whether received signals comprising the first physical layer identifier value are associated with different cell identities.

34. The method of claim 33, wherein cell identities are unique within a public land mobile network.

35. An apparatus for wireless communication, comprising:
a processing system configured to determine that an access terminal is a candidate for handover to an access point that uses a first physical layer identifier value, and further configured to determine that a plurality of access points use the first physical layer identifier value; and
a communication component configured to hand-over, as a result of the determination that the plurality of access points use the first physical layer identifier value, the access terminal to another access point that uses a second physical layer identifier value that is different from the first physical layer identifier value.

36. The apparatus of claim 35, wherein the determination that the plurality of access points use the first physical layer identifier value comprises determining whether received signals comprising the first physical layer identifier value are associated with different timing.

37. The apparatus of claim 36, wherein the different timing comprises:
a first timing difference between a first one of the access points and a reference access point; and
a second timing difference between a second one of the access points and the reference access point.

38. The apparatus of claim 37, wherein the reference access point is a serving access point.

39. The apparatus of claim 37, wherein at least one of the first timing difference and the second timing difference is obtained using cell synchronization information.

40. The apparatus of claim 35, wherein the determination that the plurality of access points use the first physical layer identifier value comprises determining that a value based on a quantity of handover failures associated with the first physical layer identifier meets or exceeds a threshold.

41. The apparatus of claim 35, wherein the first and second physical layer identifiers comprise primary scrambling codes or physical cell identifiers.

42. The apparatus of claim 35, wherein each of the access points comprises a femtocell.

43. The apparatus of claim 35, wherein the determination that the plurality of access points use the first physical layer identifier value comprises determining whether received signals comprising the first physical layer identifier value are associated with different cell identities.

44. The apparatus of claim 43, wherein cell identities are unique within a public land mobile network.

45. An apparatus for wireless communication, comprising:
means for determining that an access terminal is a candidate for handover to an access point that uses a first physical layer identifier value;
means for determining that a plurality of access points use the first physical layer identifier value; and
means for handing-over, as a result of the determination that the plurality of access points use the first physical layer identifier value, the access terminal to another access point that uses a second physical layer identifier value that is different from the first physical layer identifier value.

46. The apparatus of claim 45, wherein the determination that the plurality of access points use the first physical layer identifier value comprises determining whether received signals comprising the first physical layer identifier value are associated with different timing.

47. A computer-program product, comprising:
computer-readable medium comprising code for causing a computer to:
determine that an access terminal is a candidate for handover to an access point that uses a first physical layer identifier value;
determine that a plurality of access points use the first physical layer identifier value; and
hand-over, as a result of the determination that the plurality of access points use the first physical layer identifier value, the access terminal to another access point that uses a second physical layer identifier value that is different from the first physical layer identifier value.

48. The computer-program product of claim 47, wherein the determination that the plurality of access points use the first physical layer identifier value comprises determining whether received signals comprising the first physical layer identifier value are associated with different timing.

49. A method of wireless communication, comprising:
determining that a plurality of access points use the same physical layer identifier value; and
sending, as a result of the determination, a request to at least one of the access points requesting use of a different physical layer identifier value.

50. The method of claim 49, wherein the determination that the plurality of access points use the same physical layer identifier value comprises determining whether received signals comprising the physical layer identifier value are associated with different timing.

51. The method of claim 50, wherein the different timing comprises:
a first timing difference between a first one of the access points and a reference access point; and
a second timing difference between a second one of the access points and the reference access point.

52. The method of claim 51, wherein the reference access point is a serving access point.

53. The method of claim 51, wherein at least one of the first timing difference and the second timing difference is obtained using cell synchronization information.

54. The method of claim 49, wherein the determination that the plurality of access points use the same physical layer identifier value comprises determining that a value based on a quantity of handover failures associated with the physical layer identifier meets or exceeds a threshold.

55. The method of claim 49, wherein the physical layer identifier comprises a primary scrambling code or a physical cell identifier.

56. The method of claim 49, wherein each of the access points comprises a femtocell.

57. The method of claim 49, wherein the determination that the plurality of access points use the same physical layer identifier value comprises determining whether received signals comprising the physical layer identifier value are associated with different cell identities.

58. The method of claim 57, wherein cell identities are unique within a public land mobile network.

59. An apparatus for wireless communication, comprising:
a processing system configured to determine that a plurality of access points use the same physical layer identifier value; and
a communication component configured to send, as a result of the determination, a request to at least one of the access points requesting use of a different physical layer identifier value.

60. The apparatus of claim 59, wherein the determination that the plurality of access points use the same physical layer identifier value comprises determining whether received signals comprising the physical layer identifier value are associated with different timing.

61. The apparatus of claim 60, wherein the different timing comprises:
a first timing difference between a first one of the access points and a reference access point; and
a second timing difference between a second one of the access points and the reference access point.

62. The apparatus of claim 61, wherein the reference access point is a serving access point.

63. The apparatus of claim 61, wherein at least one of the first timing difference and the second timing difference is obtained using cell synchronization information.

64. The apparatus of claim 59, wherein the determination that the plurality of access points use the same physical layer identifier value comprises determining that a value based on a quantity of handover failures associated with the physical layer identifier meets or exceeds a threshold.

65. The apparatus of claim 59, wherein the physical layer identifier comprises a primary scrambling code or a physical cell identifier.

66. The apparatus of claim 59, wherein each of the access points comprises a femtocell.

67. The apparatus of claim 59, wherein the determination that the plurality of access points use the same physical layer identifier value comprises determining whether received signals comprising the physical layer identifier value are associated with different cell identities.

68. The apparatus of claim 67, wherein cell identities are unique within a public land mobile network.

69. An apparatus for wireless communication, comprising:
means for determining that a plurality of access points use the same physical layer identifier value; and
means for sending, as a result of the determination, a request to at least one of the access points requesting use of a different physical layer identifier value.

70. The apparatus of claim 69, wherein the determination that the plurality of access points use the same physical layer identifier value comprises determining whether received signals comprising the physical layer identifier value are associated with different timing.

71. A computer-program product, comprising:
computer-readable medium comprising code for causing a computer to:
determine that a plurality of access points use the same physical layer identifier value; and
send, as a result of the determination, a request to at least one of the access points requesting use of a different physical layer identifier value.

72. The computer-program product of claim 71, wherein the determination that the plurality of access points use the same physical layer identifier value comprises determining whether received signals comprising the physical layer identifier value are associated with different timing.

73. A method of wireless communication, comprising:
receiving information indicative of a timing difference between a first femtocell and a second femtocell; and
determining an identity of the first femtocell based on the received timing information.

74. The method of claim 73, wherein the determination of the identity comprises:
comparing a first time difference based on the received information with a plurality of time differences associated with a set of femtocells;
identifying one of the plurality of time differences that best matches the first time difference; and
determining an identity of each femtocell associated with the identified time difference.

75. The method of claim 73, wherein the timing information comprises:
a first timing difference between the first femtocell and a reference access point; and
a second timing difference between the second femtocell and the reference access point.

76. The method of claim 75, wherein the reference access point is a serving access point.

77. The method of claim 75, wherein at least one of the first timing difference and the second timing difference is obtained using cell synchronization information.

78. The method of claim 73, further comprising receiving a cell identifier, wherein the determination of the identity comprises identifying femtocells within a coverage area of a macro access point that is associated with the cell identifier.

79. The method of claim 78, wherein:
the cell identifier identifies a cell of the second femtocell; and
the second femtocell is a source femtocell for handover of an access terminal to the first femtocell.

80. The method of claim 78, wherein the cell identifier identifies a cell of the macro access point.

81. An apparatus for wireless communication, comprising:
a communication component configured to receive information indicative of a timing difference between a first femtocell and a second femtocell; and
a processing system configured to determine an identity of the first femtocell based on the received timing information.

82. The apparatus of claim 81, wherein the determination of the identity comprises:
comparing a first time difference based on the received information with a plurality of time differences associated with a set of femtocells;
identifying one of the plurality of time differences that best matches the first time difference; and
determining an identity of each femtocell associated with the identified time difference.

83. The apparatus of claim 81, wherein the timing information comprises:
a first timing difference between the first femtocell and a reference access point; and
a second timing difference between the second femtocell and the reference access point.

84. The apparatus of claim 83, wherein the reference access point is a serving access point.

85. The apparatus of claim 83, wherein at least one of the first timing difference and the second timing difference is obtained using cell synchronization information.

86. The apparatus of claim 81, further comprising receiving a cell identifier, wherein the determination of the identity comprises identifying femtocells within a coverage area of a macro access point that is associated with the cell identifier.

87. The apparatus of claim 86, wherein:
the cell identifier identifies a cell of the second femtocell; and
the second femtocell is a source femtocell for handover of an access terminal to the first femtocell.

88. The apparatus of claim 86, wherein the cell identifier identifies a cell of the macro access point.

89. An apparatus for wireless communication, comprising:
means for receiving information indicative of a timing difference between a first femtocell and a second femtocell; and
means for determining an identity of the first femtocell based on the received timing information.

90. The apparatus of claim 89, wherein the determination of the identity comprises:
comparing a first time difference based on the received information with a plurality of time differences associated with a set of femtocells;
identifying one of the plurality of time differences that best matches the first time difference; and
determining an identity of each femtocell associated with the identified time difference.

91. A computer-program product, comprising:
computer-readable medium comprising code for causing a computer to:
receive information indicative of a timing difference between a first femtocell and a second femtocell; and
determine an identity of the first femtocell based on the received timing information.

92. The computer-program product of claim 91, wherein the determination of the identity comprises:
comparing a first time difference based on the received information with a plurality of time differences associated with a set of femtocells;
identifying one of the plurality of time differences that best matches the first time difference; and
determining an identity of each femtocell associated with the identified time difference.
